(19) United States
(12) Patent Application Publication
(10) Pub. No.: US 2020/0229171 A1
(43) Pub. Date: Jul. 16, 2020

(54) METHODS OF AUTONOMOUS RESOURCE SELECTION IN NEW RADIO (NR) VEHICLE-TO-EVERYTHING (V2X) SIDELINK COMMUNICATION

(71) Applicant: Intel Corporation, Santa Clara, CA (US)

(72) Inventors: Alexey Khoryaev, Nizhny Novgorod NIZ (RU); Mikhail Shilov, Nizhny Novgorod NIZ (RU); Sergey Panteleev, Nizhny Novgorod NIZ (RU); Sergey Sosnin, Zavolzhie NIZ (RU)

(21) Appl. No.: 16/829,517

(22) Filed: Mar. 25, 2020

Related U.S. Application Data
(60) Provisional application No. 62/828,315, filed on Apr. 2, 2019.

(51) Int. Cl. H04W 72/04; H04B 7/0413; H04W 72/08; H04W 72/10; H04W 4/40

(52) U.S. Cl. CPC H04W 72/0406; H04B 7/0413; H04W 4/40; H04W 72/10; H04W 72/08

(57) ABSTRACT

Various embodiments herein describe methods for autonomous resource selection in new radio (NR) vehicle-to-everything (V2X) sidelink communication. For example, a sensing-based method of resource selection is described, including a sensing window design and techniques for selecting resources and transmitting resource reservation information. Other embodiments may be described and claimed.

### CROSS REFERENCE TO RELATED APPLICATION

The present application claims priority to U.S. Provisional Patent Application No. 62/828,315, titled “METHOD OF AUTONOMOUS RESOURCE SELECTION IN NR-V2X SIDELINK COMMUNICATION,” which was filed Apr. 2, 2019, the disclosure of which is hereby incorporated by reference.

### FIELD

Embodiments of the present invention relate generally to the technical field of wireless communications.

### BACKGROUND

The design for Long Term Evolution (LTE) vehicle-to-vehicle (V2V) communication was based on the assumption of periodic broadcast traffic. Based on this assumption, the UE made semi-persistent decision on selected resources for V2V transmissions. The LTE V2V design was not optimized for aperiodic traffic with large variations in packet arrival times and packet payload sizes.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1A illustrates a sensing scheme including a long-term sensing window and a short-term sensing window, for the case when no collision is detected within the short-term sensing window with respect to the selected candidate resources for sidelink transmission, in accordance with various embodiments.

FIG. 1B illustrates the sensing scheme when a collision is detected within the short-term sensing window, and the initially selected candidate resources need to be adjusted (reselected), in accordance with various embodiments.

FIG. 2A illustrates a resource selection window for the case when a packet delay budget is less than the resource selection window, in accordance with various embodiments.

FIG. 2B illustrates the resource selection window for the case when the packet delay budget exceeds the resource selection window, in accordance with various embodiments.

FIG. 3 illustrates an operation flow/algorithmic structure in accordance with some embodiments.

FIG. 4 illustrates another operation flow/algorithmic structure in accordance with some embodiments.

FIG. 5 illustrates an example of infrastructure equipment in accordance with various embodiments.

FIG. 6 depicts example components of a computer platform or device in accordance with various embodiments.

FIG. 7 depicts example components of baseband circuitry and radio frequency end modules in accordance with various embodiments.

FIG. 8 is a block diagram illustrating components, according to some example embodiments, able to read instructions from a machine-readable or computer-readable medium (for example, a non-transitory machine-readable storage medium) and perform any one or more of the methodologies discussed herein.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A or B” and “A and/or B” mean (A), (B), or (A and B). For the purposes of the present disclosure, the phrases “A, B, or C” and “A, B, and/or C” mean (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include any combination of integrated circuits (for example, a field-programmable gate array (FPGA), an application specific integrated circuit (ASIC), etc.), discrete circuits, combinational logic circuits, system on a chip (SOC), system in a package (SiP), that provides the described functionality. In some embodiments, the circuitry may execute one or more software or firmware modules to provide the described functions. In some embodiments, circuitry may include logic, at least partially operable in hardware.

Various embodiments herein provide techniques for new radio (NR) vehicle-to-everything (V2X) communication, including techniques related to autonomous resource selection and associated channel access procedures. In various embodiments, the resource selection procedure may support both periodic and aperiodic traffic types with large variations in packet sizes. In some embodiments, the resource selection procedure may efficiently handle unicast, groupcast and broadcast communication types (e.g., with arbitrary traffic patterns).

For example, the following aspects of the autonomous NR-V2X resource selection procedure are described herein in accordance with various embodiments:
Resource reservation mechanism
Resource allocation signaling details
Sidelink measurements used to assist resource selection procedure
Details of joint handling of unicast, groupcast and broadcast transmissions
Resource selection details

Mode-2 Sensing and Resource Selection

Resource Reservation

In order to enable efficient operation of sensing-based resource selection, the resource reservation mechanism is needed. NR V2X Mode-2 is expected to support reservation of sidelink resources for blind retransmission of a transport block (TB). The following aspects need to be decided for NR-V2X design:
1) Whether reservation is supported for initial transmission of a TB; and
2) Whether reservation is supported for potential retransmissions based on hybrid automatic repeat request (HARQ) feedback.

In accordance with various embodiments herein, resource reservation may be used for initial transmission of a sidelink message/TB. The reservation for initial transmission is needed in order to improve performance of initial transmission compared to the scheme based on random resource selection. Additionally, if the initial transmission spans multiple consecutive slots, benefit of sensing depends on sidelink control information (SCI) processing delay. If, for example, SCI processing delay is two slots, then initial transmission should span at least 4 slots in order for sensing to have at least some effect. Accordingly, resource reservation for initial transmission is beneficial.

Another observation that can be drawn is that in case of reservation, blind retransmissions should be distributed in resource selection window in order for sensing to have meaningful effect.

With respect to 2) above, reservation for potential retransmissions based on HARQ feedback, the reservation should be applied as well, otherwise UE will need to dynamically contend/compete for sidelink retransmission based on HARQ feedback.

Several enhancements to support resource reservation for NR V2X Mode-2 are described in sub-sections below.

Resource Reservation Triggers

As discussed above, resource reservation may be especially beneficial in case of standalone transmission or transmission which use consecutive time slots. Some potential resource reservation signaling triggers include:

Trigger 1: Triggering of resource selection for single transmission

Trigger 2: Set of consecutive time resources is selected during resource selection procedure

Trigger 3: Unicast communication procedures. For unicast communication long-term link quality may need to be guaranteed.

Trigger 4: Resource allocation for periodic traffic. Resource reservation may be triggered for periodic traffic resource provisioning during semi-persistent resource reselection.

Trigger 5: Groupcast communication procedures. Group head UE may send message with reservation information to book resources for intra-group communication

Trigger 6: Resource reservation signaling is preconfigured by higher layers

Resource Reservation Information Signaling

Resource reservation information may potentially be carried out by:

Alternative 1: Transmission in physical sidelink control channel (PSCCH) resource pool. In this case reservation information is transmitted by SCI. The following design options may be used to support SCI with resource reservation information (SCI-R):
Option 1: Use same SCI format as used for SCI with resource assignment (SCI-A) with a field to differentiate assignment from reservation. For example, the field may have a first value to indicate that the SCI is for resource reservation (SCI-R) or a second value to indicate that the SCI is for resource assignment (SCI-A).
Option 2: Separate SCI format may be introduced for SCI-R. The main disadvantage of this option is the increased SCI decoding complexity.

If alternative 1 is used for reservation information indication, enhancements to enable SCI-A and SCI-R SCIs distinguishing may be needed. For example, if one-shot transmission is used to deliver packets, reception of SCI-R instead of SCI-A leads to packet loss. Some design options that allow to distinguish SCI-R and SCI-A include the following:
Option 1. Use different PSCCH formats for SCI-A and SCI-R transmission. Different sets of resources may eliminate potential problems of increased complexity of blind decodings if different SCI formats are used. In addition, non-overlapped sets of resources may be configured for different PSCCH formats.
Option 2. Different search spaces for SCI-A and SCI-R assuming same PSCCH format. Different sets of PSCCH resources for transmission of SCIs with assignment and reservation information may be configured. In this case receiver UE may detect the presence of SCI with assignment and/or reservation information and decide which SCI should be prioritized for decoding.
Option 3. Use of different sets of demodulation reference signals for SCI-R and SCI-A. In this case even if the same sets of resources are configured for SCI-A and SCI-R transmission, UE may detect the presence of SCI with assignment and prioritize its decoding over decoding of SCI with reservation information.

Alternative 2: Transmission in physical sidelink shared channel (PSSCH). In this case resource reservation signaling may complement PSSCH data transmission and share PSSCH resources with data transmission. Assistance information with sharing of sensing results (e.g. candidate resource set or subset of candidate resources) in unicast communication may sent from RX side to TX or vice versa.
In one embodiment, predefined set of PSSCH resources is allocated for reservation signal transmission.
In another embodiment, reservation information can be multiplexed with data payload. In this case multiplexing parameters (e.g. reservation information size) may be carried by MAC header.

In addition, power control to manage communication range of SCI-R transmission may also be used. Transmit power of the standalone SCI is scaled down to align it with SCI transmit power used for SCI transmission with data.

Resource Reservation Signal Resource Selection

As discussed above, the UE may transmit resource reservation information to indicate the resources to be used to transmit the sidelink transmission. In some embodiments, the UE may select the resources for the sidelink transmission using one or more of the following:

Option 1: Random resource selection. In order to enable early reservation information sharing, resources may be randomly selected among predefined set of nearest in time resources.

Option 2: Sensing-based resource selection. In some embodiments, this option may be used for reservation information transmission using both PSCCH and PSSCH channels. The sensing procedure used for data resource selection may be used in this case. In addition, nearest-in time non-congested resources may be prioritized for reservation signal transmission. If multiple resources suitable for reservation signal transmission are associated with selected resource, resource for transmission may further be selected among candidate resources. For example, the resources for transmission may be selected according to one or more of the following alternatives:
Alternative 1: Random resource selection
Alternative 2: Based on preconfigured parameters (e.g. using preconfigured set of resources)
Alternative 3: Based on additional resources sensing. For example, if reservation information is conveyed with SCI and multiple control resources candidates exist, SCI may carry transmission hopping index to indicate occupied resources. In that case received may select less congested control resource based on competing SCI transmission hopping information and SCI RSRP measurements.

SCI Payload Information

To indicate allocated and/or reserved resources and to enable sensing-based resource selection, SCI should carry information about allocated resources or their potential resource allocations in future.

Signaling Resource Granularity

To indicate resource allocations in time, in one embodiment, slot granularity may be used. In another embodiment, preconfigured time resource which may include multiple slots may be used.

For frequency resources allocations, as one alternative, PRB granularity may be used for signaling. In another alternative, a group of consecutive PRBs denoted as subchannel may be used to reduce signaling overhead.

SCI Content

The SCI may include one or more of the following information: Resource allocation information
Number of allocated frequency resources (e.g. PRB, subchannel)
Start frequency resource location for each transmission.
Start time resource location for each transmission. For example, the indication of the start time resource location may include one or more of:
   Option 1: Absolute time index may be indicated
   Option 2: Relative resource time index calculated relatively to known time reference point.
   Option 3: Chain signaling, where each next transmission time index is indicated relatively to the previous one.
   Option 4: Allocation pattern index indication. To enable this signaling option, all combinations of allocated time resources within predefined time interval should be enumerated. List of enumerated patterns may be preconfigured in each UE. In SCI with assignment or reservation information, index of the used time allocation pattern is signaled. In one design option, pattern for the all transmissions may be generated. In another option, pattern for the only upcoming set of transmissions may be indicated.
Time resources aggregation factor. To carry transport block of large size, each transmission may occupy multiple slots which have preconfigured linkage and addressed with single set of time/frequency parameters. Time resources aggregation factor is used to indicate the number of time resources used for single TB transmission.
Resource allocation periodicity.
Total number of transmissions.

In order to minimize signaling overhead for one or several transmissions, the joint signaling may be introduced for start frequency resource location and number of allocated resources. In this case the LTE SL resource allocation signaling mechanism with RIV value may be used.

Layer 1 Identifiers
Source identifier (Source ID)
Destination identifier (Destination ID)

QoS Level Indicators (e.g. Priority)

Retransmission index. This field may be omitted from reservation information and may be carried only by SCI with assignment. In order to determine the set of indicated resources, retransmission index should be known at the receiver side. The following alternatives exist:
Alternative 1: Explicit indication. Separate field which carry retransmission index is added to the SCI.
Alternative 2: Implicit indication: Retransmission index may be derived from values indicated in other fields. For example, for aperiodic traffic initial transmission should indicate all resources and, hence, all fields related to the signaled number of transmission should be initialized with valid values. The 1st retransmission may not carry information about initial transmission and fields related to the initial transmission resource allocation may be initialized with invalid value. In this case, retransmission index may be determined by validation of the resource allocation fields values.

Table 1 illustrates example contents of the SCI with resource reservation information in accordance with various embodiments.

TABLE 1
SCI Content

| | Number | |
|---|---|---|
| SCI Field | of bits | Design assumption |
| Number of allocated | 4 | Frequency allocation is measured |
| frequency resources | | in subchannels. It is assumed, that |
| | | whole band is divided into maxi- |
| | | mum of 16 sub channels |
| Transmissions | 16 | Time pattern of 32 slot size |
| start time | | is assumed. |
| | | Up to 3 time resources beside the |
| | | current SCI are indicated |
| | | with pattern |
| | | nBits = ceil(nchoosek(32,4)) |
| Number of | 2 | Up to 4 independently selected |
| transmissions | | resources are signaled |
| Period | 2 | 4 different periods are indicated |
| Time resource | 2 | Up to 4 resources may |
| aggregation factor | | be aggregated |
| Retransmission index | 2 | Up to 4 transmissions are signaled |
| Start frequency | 12(3x4Bit) | Up to 3 transmissions different |
| resource | | from current one are signaled. It is |
| | | assumed, that whole band |
| | | is divided into |
| Priority | 3 | maximum of 16 subchannels. |
| Source ID | 8 | |
| Destination ID | 8 | |

In addition to resource allocation parameters, the SCI with resource assignment information may include:

HARQ information. To enable HARQ combining, used redundancy version index (RVI) should be determined. The following alternatives may be used:
Alternative 1: Derive redundancy version index from retransmission index using preconfigured retransmission index-to-RVI mapping table.
Alternative 2: Explicitly indicate used redundancy version index in SCI.

MIMO Mode

Modulation and Coding Scheme

Information Extracted from SCI Decoding

SCI decoding is used to extract information on occupied sidelink transmission resources, including resources for initial transmission, retransmissions and semi-persistently reserved resources. Besides the occupied sidelink resources, UE performing resource reselection extracts information on sidelink transmission priority and/or generalized QoS target/level of sidelink transmission. This information is further taken into account in resource selection procedure.

SCI decoding is used to extract information on:
Occupied sidelink transmission resources (including initial transmission, (re)-transmissions, and semi-persistently reserved sidelink resources)
Sidelink communication type (unicast, groupcast, broadcast)
Communication group affiliation (by identifying source and destination IDs)
QoS level of sidelink transmission

Sidelink Measurements

It was previously agreed that L1 SL-RSRP based on sidelink DMRS would be used for NR V2X. However, the following aspects have not been previously determined:
1) Which sidelink physical channel is used for L1 SL-RSRP measurements?
2) Whether/which measurement is used if the corresponding SCI is not decoded e.g. SL-RSRP after blind DMRS detection, SL-RSSI?

With respect to the sidelink physical channel used for L1 SL-RSRP measurements, at least PSSCH should be used for L1 SL-RSRP. When UE reserves resources for retransmissions or semi-persistent resources for subsequent retransmissions this measurement can be used in resource selection to decide whether these resources are excluded from candidate resource set.

The L1 SL-RSRP measurement over PSCCH can be used in case if standalone PSCCH transmission is supported (e.g. for resource reservation, preemption, etc.). In this case the PSCCH L1 SL-RSRP measurement should be properly scaled to represent PSSCH L1 SL-RSRP on reserved resources.

In addition, support of SL-RSSI measurement is also useful, and may be used. For instance, if transmission from UE-1 was decoded on sub-channel #1 and UE-1 reserve resources for (re)-transmission in future slots, then considering IBE impact it is desirable to know the level of RX signal power on other sub-channels if there is no other UEs detected. From that perspective SL-RSSI can be used as a secondary metric if there is no SL-RSRP measurement available on candidate resource for transmission.

SL-RSSI measurement can be used to form candidate resource set for sidelink transmission from all non-excluded resources.

Handling of Unicast and Groupcast Transmissions by Sensing Procedure

Considering that for NR-V2X communication all types of sidelink communication (unicast, groupcast and broadcast) may share the same resources the sensing procedure may need to separately handle transmissions from unicast and groupcast links comparing to broadcast and prioritize these transmissions over broadcast ones. If needed priority information may be considered here.

In case of unicast and groupcast communication, sensing procedure detects and indicates resources which are reserved for transmission by members of the same group/unicast pair. Resources reserved for transmission by UEs that belong to the same group/unicast pair are automatically excluded from candidate resource set.

Alternative option is to consider such resources as a candidates with a lower priority or probability (e.g. only if there is no other resources available). For instance, the SL-RSRP threshold to exclude these resources can be lower and priority of transmitter should be higher than priority level of their transmission.

Resource Selection Design Aspects

Considering that for NR-V2X communication all types of sidelink communication (unicast, groupcast and broadcast) may share the same set of resources, the sensing procedure may need to simultaneously handle unicast, groupcast and broadcast transmissions. For example, one or more of the following options may be used:
Option 1. Treat transmissions from the same communication group (unicast or groupcast) as transmissions of higher priority and exclude their resources from candidate resource set
Option 2. Jointly take into account communication group affiliation information, type of the transmission and indicated priority during resource selection procedure. In this case parameters used in resource selection (e.g. SL-RSRP threshold) may be a function of listed above parameters
Option 3: Resources reserved for transmission by UEs that belong to the same group/unicast pair are automatically excluded from candidate resource set

Sensing Window Design

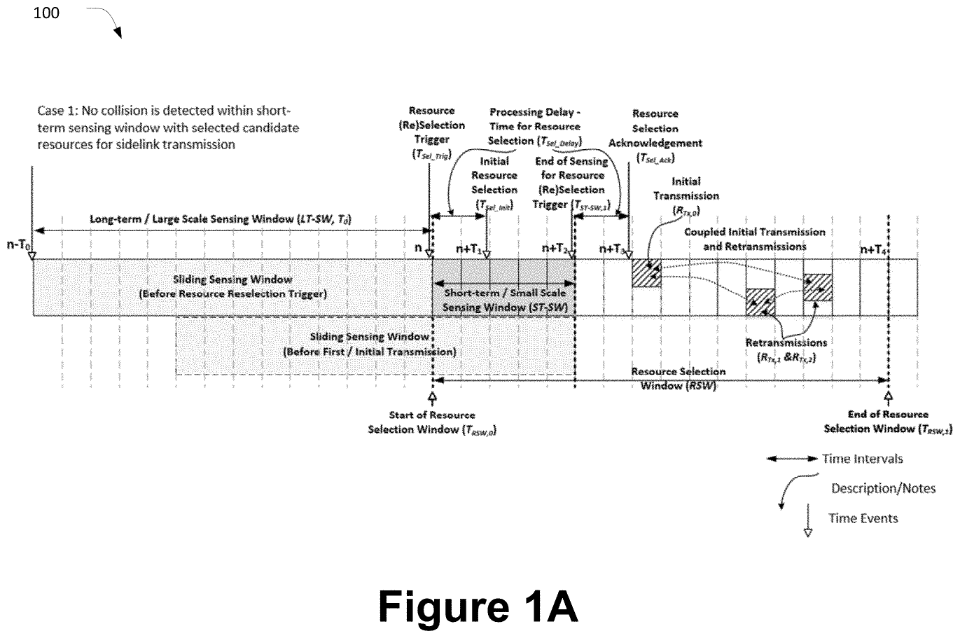

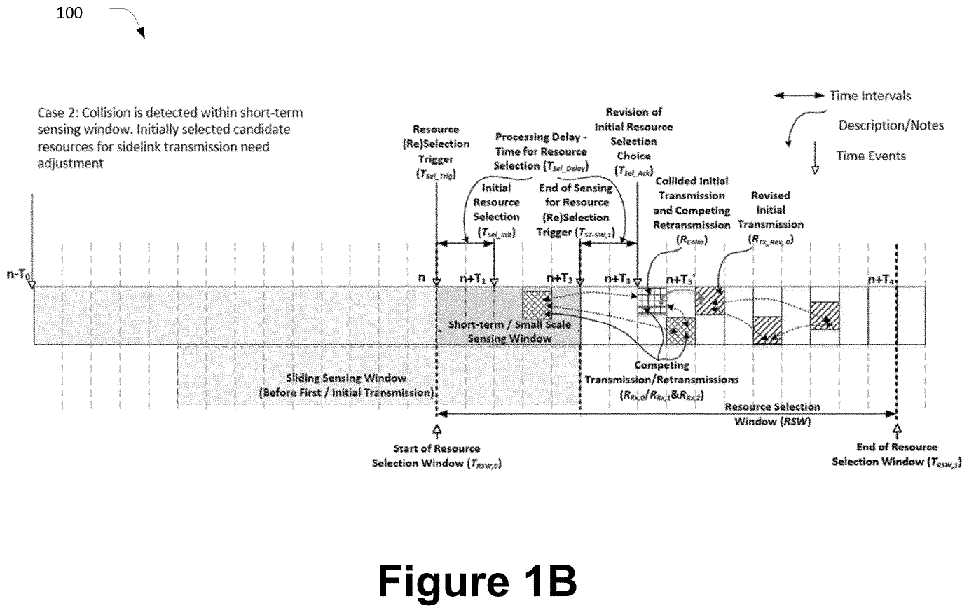

For NR-V2X communication, the sensing window should start ahead of resource (re)-selection trigger (at time instance n) and continues after resource (re)-selection trigger until the time instance (n+T₂), which is determined by the first sidelink transmission minus UE processing delay on resource selection. The NR-V2X sensing window has variable duration and can be viewed as a sensing window composed from two parts (see FIGS. 1A and 1B), a long-term sensing window and a short-term sensing window.

The long-term sensing window (LT-SW) is a sensing window that the UE is expected to monitor ahead of each resource (re)-selection trigger (at time instance: n). The long-term sensing window may have a fixed duration, T0, the value of which may be configurable.

The short-term sensing window (ST-SW) is a sensing window that starts immediately after resource (re)-selection trigger, e.g. at time instance (n+1) and continues until the time instance (n+T₂) which is determined by the first sidelink transmission at (n+T₃) minus UE processing delay on resource selection Tproc (T_{Sel_Delay} in FIGS. 1A and 1B).

It should be noted that long-term sensing window has configurable but fixed duration, while the duration of short-term sensing window may vary in time and is subject to the resource selection decision process. The main motivation to divide sensing window in two parts and define short-term sensing window on top of long-term sensing window is to process resource reservations announced inside of resource selection window and if it is necessary to refine initially selected sidelink resources for transmission if conflict is detected. For example, FIG. 1A illustrates the sensing scheme 100 when no collision is detected within the short-term sensing window with respect to the selected candidate resources for sidelink transmission. Additionally, FIG. 1B illustrates the sensing scheme 100 when a collision is detected within the short-term sensing window, and the initially selected candidate resources need to be adjusted (reselected).

Accordingly, in the sensing window design described herein for NR-V2X communication, the sensing window starts at (n−T₀) ahead of each resource (re)-selection trigger at time instance n and continues till the time instance (n+T₂) which is determined by the first sidelink PSCCH transmission at (n+T₃)—minus UE processing delay on resource selection (Tproc). The sensing window may be composed of two parts: a long-term sensing window and a short-term sensing window. The long-term sensing window (LT-SW) is a sensing window UE is expected to monitor ahead of resource (re)-selection trigger. The long-term sensing window has configurable and fixed duration.

The short-term sensing window (ST-SW)—is a sensing window that starts immediately after resource (re)-selection trigger and continues till the time instance of sidelink transmission—minus UE processing delay on resource selection.

It should be noted that while the sensing window design is described herein with a long-term sensing window and a short-term sensing window, the sensing window design may also be considered as one sensing window that includes the features of both the long-term sensing window and the short-term sensing window described herein.

Timescale and Conditions for Resource (Re-)selection

The resource selection window interval may be bounded by packet delay budget (PDB) requirement. If PDB is large (e.g. 100 ms) it can be restricted by pre-configuration or specification, e.g. min(PDB, TRSW) or TRSW<TPDB, where TRSW is configured resource selection window (RSW) duration.

The need to restrict resource selection window is to accommodate reasonable overhead in SCI signaling in order to point to selected resources including initial transmission and retransmissions (e.g. 4 sidelink PSCCH/PSSCH transmissions per TB in total). In addition, from the receiver (RX) perspective, the time interval where to collect retransmissions should be limited. In some embodiments, this time span should not exceed 32 slots (e.g. 4 transmissions should be accommodated within the window of 32 slots).

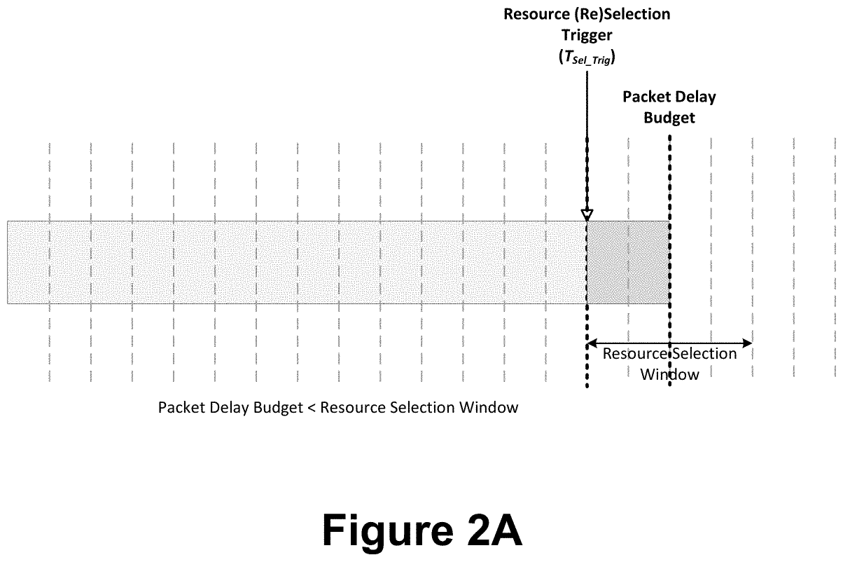

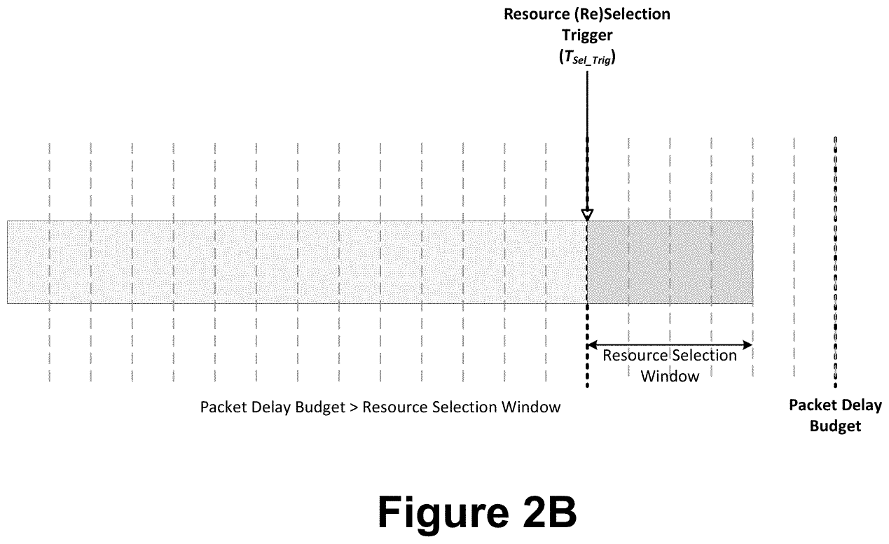

Therefore, as shown in FIG. 2A, if the PDB is less than the RSW, then the RSW should be bounded by the PDB. However, as shown in FIG. 2B, if the PDB exceeds the RSW, UE should aim to transmit within resource selection window. If UE was not able to transmit within resource selection window and remaining PDB still sufficient, UE may re-trigger resource (re)-selection again to select resources and complete packet transmission in time.

Accordingly, in the resource selection window described herein, the resource selection window is defined as a time interval during which the UE selects sidelink resources for transmission. The resource selection window starts after (e.g., right after) resource (re)-selection trigger and may be bounded by min(T_{PDB}, T_{RSW}), where
T_{PDB}—remaining packet delay budget
T_{RSW}—configurable resource selection window duration.

PSCCH/PSSCH Resource Selection Triggers

In various embodiments, one or more of the following events may trigger sidelink resource (re-)selection for NR V2X communication: (1) UE determines that a new packet is arrived (e.g., ready for transmission) and there is no sidelink resources reserved for its transmission; (2) UE determines that new packet is arrived and cannot be transmitted in reserved resources (e.g. lack of reserved sidelink resources, the target QoS level is not guaranteed); (3) UE determines that resource reservation is expired (e.g., based on timer or counter of transmitted TBs) and new packet is arrived; (4) the UE determines that resource which is used for actual transmission (e.g. after transmission announcement in PSCCH by means of scheduling assignment or reservation signaling) was preempted by other UE transmission and a new resource selection condition is met; and/or (5) UE selected resources for transmission but has not transmitted on selected resource and there is still remaining packet delay budget to accomplish transmission in time.

In some embodiments, the trigger (3) may be applicable to a semi-persistent transmission scheme. In the case of trigger (5), the UE may trigger additional resource selection.

PSCCH/PSSCH Resource Selection Details

Once resource (re)selection is triggered, UE is expected to form candidate resource set composed from at least M candidate resources and selects R tentative candidate resources for sidelink transmission. It is assumed that PSCCH and PSSCH resources are associated (linked) with each other so that both resources are selected.

When selecting resources for transmission UE prioritizes selection of at least one earliest in time candidate resource among N earliest in time resources (N<M) in order to announce its decision as soon as possible either through scheduling assignment or standalone resource reservation signaling (standalone PSCCH transmission can be used for that purpose).

UE continues to monitor transmissions within resource selection window (e.g., short term sensing) until the first sidelink transmission (either actual data transmission or standalone reservation signaling). If UE detects through SCI decoding that recently announced transmissions from other UEs collide with tentatively selected candidate resources for transmission (R), UE reselects R tentative candidate resources from candidate resource set to avoid conflict (e.g. by excluding conflicting candidate resources). If there is no conflict detected, UE proceed with transmission on previously selected R candidate resources, otherwise UE makes new iteration and reselects R candidate resources (refinement of candidate resources—see FIG. 1B).

Accordingly, the resource selection procedure described herein may include one or more of the following aspects:
When resource (re)-selection is triggered, UE forms initial candidate resource set of M resources based on sensing results collected before resource reselection trigger (e.g. in long-term resource selection window). This may be performed according to the resource exclusion procedure.
UE prioritizes transmission on a subset of the earliest in time candidate resources by randomly picking one resource out of N earliest in time resources.
UE refines initial candidate resource set based on monitoring of sidelink transmissions within resource selection window at least until the first in time transmission on selected candidate resource.

Handling of Periodic and Aperiodic Traffic

NR V2X should optimally support periodic and aperiodic traffic as well as their mixture. For handling periodic traffic, it is desirable to reduce sensing window (e.g. long-term sensing window) compared to LTE in order to relax requirements on memory and complexity of processing. The sensing window should not exceed the maximum transmission period which is according to our understanding does not exceed 1000 ms. In practice, this window can be further reduced to hundreds of ms (e.g. 200 ms) or made configurable. Periodic transmissions with larger transmission period can be handled as aperiodic traffic, since anyway interference environment may change significantly in one second.

For periodic traffic, the optimal procedure from the resource allocation perspective is to enable semi-persistent resource reservation and timer or counter based resource reselection similar to LTE. In this case, the long-term sensing window should cover the target transmission period.

For aperiodic traffic, the dynamic resource selection is a more reasonable choice since it transmission pattern is not predictable. Therefore, in various embodiments, NR V2X may support one or more of the following schemes for resource reselection: a dynamic resource reselection scheme, where resources are selected for transmission of each TB; and/or a semi-persistent resource reselection scheme, where resources are semi-persistently allocated for transmission of multiple TBs. In various embodiments, the dynamic resource selection scheme may be applied to periodic transmissions for which the period exceeds configured sensing window duration.

In order to handle periodic and aperiodic traffic, the long and short term sensing procedures complement each other and can be viewed as a unified single solution. From system perspective, the following options can be enabled or disabled:

Option 1. Long term sensing is enabled w/o short term sensing. This option is valid if only semi-persistent/periodic transmissions are considered with semi-persistent resource selection

Option 2. Short term sensing is enabled w/o long term sensing. This option is valid if only aperiodic transmissions are considered with dynamic resource selection.

Option 3. Combination of short and long term sensing is enabled. This option is valid for both periodic and aperiodic transmissions with semi-persistent and dynamic resource selection respectively.

The choice between these options may primarily depend on configuration of long term sensing window. If long-term sensing window is a multiple of possible transmission periods then long-term sensing is enabled. If duration of long-term sensing window is equal to resource selection window then semi-persistent reservations can be considered as disabled.

Accordingly, the resource selection scheme described herein may provide support of both dynamic resource allocation, where resources are selected for transmission of each TB, and semi-persistent resource allocation, where resources are semi-persistently allocated for transmission of multiple TBs. Additionally, or alternatively, in the resource selection scheme, periodic semi-persistent transmission with periods exceeding sensing window duration (LT-SW) may be automatically treated by transmitting UE using dynamic scheme.

Quality of Service (QoS) Impact on Resource Selection

In various embodiments, the QoS attributes may have impact on sidelink resource selection. UE reselecting resources should take into account its own QoS attributes (e.g. latency, priority, etc.) as well as QoS attributes of other UEs that are indicated in SCI (e.g. priority). The latency may affect resource selection window, priority and reliability amount of resources to be reserved as well as whether to apply standalone reservation signaling or not. In addition, these parameters jointly with the thresholds on SL-RSRP measurements may affect resource exclusion procedure and preemption mechanisms. The SL-RSRP thresholds should be configured to make a decision on whether reserved sidelink resource should be excluded or not from candidate resource set. The resource exclusion procedure may be iterative to ensure that M out of Q resources (e.g. a certain percentage of resources) in resource selection window are selected as candidates.

The value of the preconfigured SL-RSRP threshold(s) may depend on priority/generalized PQI targets/levels of transmitting UEs as well as UE (re)-selecting sidelink resource.

Accordingly, in the resource selection design described herein, UE performing sensing and resource selection procedures may take into account QoS attributes of ongoing sidelink transmissions from other UEs and its QoS of its own sidelink transmission. At least sidelink transmission priority may be signalled by all UEs. Additionally, or alternatively, different SL-RSRP thresholds may be applied based on QoS attributes detected from SCI transmission and QoS attribute of UE selecting resource.

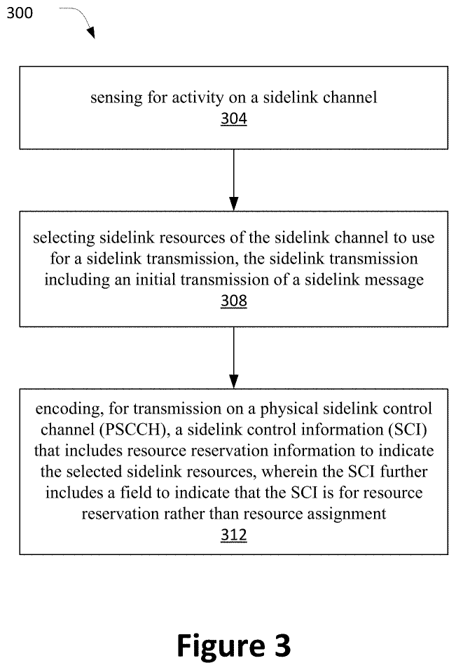

FIG. 3 illustrates an operation flow/algorithmic structure 300 in accordance with some embodiments. The operation flow/algorithmic structure 300 may be performed, in part or in whole, by a UE (e.g., UE 501a and/or UE 501b, discussed infra), or components thereof. For example, in some embodiments the operation flow/algorithmic structure 300 may be performed by the baseband circuitry implemented in the UE. In some embodiments, the UE may be an NR-V2X UE, and may use the operation flow/algorithmic structure 300 to communicate on a sidelink channel (e.g., using NR-V2X Mode 2).

At 304, the operation flow/algorithmic structure 300 may include sensing for activity on a sidelink channel (e.g., a PSSCH and/or a PSCCH). The sensing may include, for example, monitoring for transmissions on resources of the sidelink channel (e.g., from other UEs) and/or decoding one or more SCIs to determine upcoming transmissions on the sidelink channel. The sensing may be performed over a sensing window as described herein.

At 308, the operation flow/algorithmic structure 300 may further include selecting sidelink resources of the sidelink channel to use for a sidelink transmission, the sidelink transmission including an initial transmission of a sidelink message. The selection of sidelink resources may be performed according to one or more aspects of the resource selection procedure described herein.

At 312, the operation flow/algorithmic structure 300 may further include encoding, for transmission on a PSCCH, an SCI that includes resource reservation information to indicate the selected sidelink resources. In some embodiments, the SCI may include a field to indicate that the SCI is for resource reservation rather than resource assignment. The SCI may include contents and/or a format as described herein. In some embodiments, the operation flow/algorithmic structure 300 may further include encoding the sidelink message for transmission on the selected sidelink resources.

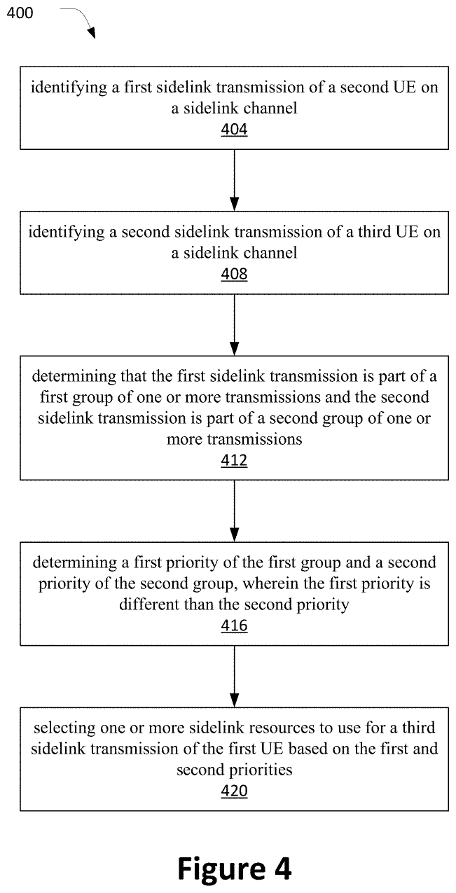

FIG. 4 illustrates another operation flow/algorithmic structure 400 in accordance with some embodiments. The operation flow/algorithmic structure 400 may be performed, in part or in whole, by a first UE (e.g., UE 501a and/or UE 501b, discussed infra), or components thereof. For example, in some embodiments the operation flow/algorithmic structure 400 may be performed by the baseband circuitry implemented in the first UE. In some embodiments, the UE may be an NR-V2X UE, and may use the operation flow/algorithmic structure 400 to communicate on a sidelink channel (e.g., using NR-V2X Mode 2).

At 404, the operation flow/algorithmic structure 400 may include identifying a first sidelink transmission of a second UE on a sidelink channel.

At 408, the operation flow/algorithmic structure 400 may include identifying a second sidelink transmission of a third UE on a sidelink channel.

At 412, the operation flow/algorithmic structure 400 may further include determining that the first sidelink transmission is part of a first group of one or more transmissions and the second sidelink transmission is part of a second group of one or more transmissions. For example, the first group of one or more transmissions may correspond to sidelink transmissions that are to be decoded by the UE, and the second group of one or more transmissions may correspond to sidelink transmissions that the UE is not to decode. Additionally, or alternatively, the first group of one or more transmissions may correspond to unicast transmissions and the second group of one or more transmissions may correspond to groupcast transmissions.

At 416, the operation flow/algorithmic structure 400 may further include determining a first priority of the first group and a second priority of the second group, wherein the first priority is different than the second priority.

At 420, the operation flow/algorithmic structure 400 may further include selecting one or more sidelink resources to use for a third sidelink transmission of the first UE based on the first and second priorities. For example, in some embodiments, the first and second priorities may correspond to respective signal power thresholds (e.g., RSRP thresholds). The first UE may determine that a sidelink resource is occupied if the respective transmission is greater than the corresponding signal power threshold.

### Systems and Implementations

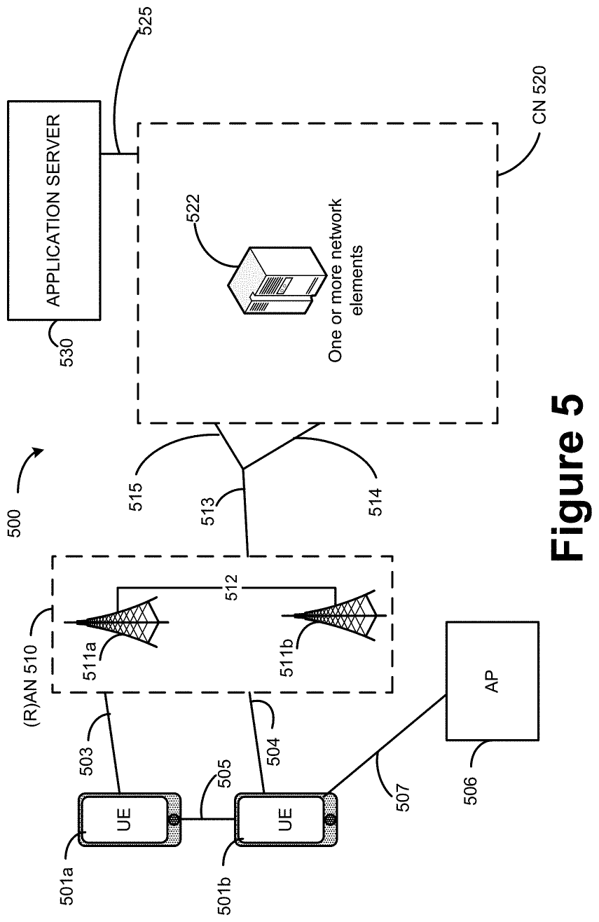

FIG. 5 illustrates an example architecture of a system 500 of a network, in accordance with various embodiments. The following description is provided for an example system 500 that operates in conjunction with the LTE system standards and 5G or NR system standards as provided by 3GPP technical specifications. However, the example embodiments are not limited in this regard and the described embodiments may apply to other networks that benefit from the principles described herein, such as future 3GPP systems (e.g., Sixth Generation (6G)) systems, IEEE 802.16 protocols (e.g., WMAN, WiMAX, etc.), or the like.

As shown by FIG. 5, the system 500 includes UE 501a and UE 501b (collectively referred to as “UEs 501” or “UE 501”). In this example, UEs 501 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some embodiments, any of the UEs 501 may be IoT UEs, which may comprise a network access layer designed for low-power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 501 may be configured to connect, for example, communicatively couple, with an or RAN 510. In embodiments, the RAN 510 may be an NG RAN or a 5G RAN, an E-UTRAN, or a legacy RAN, such as a UTRAN or GERAN. As used herein, the term “NG RAN” or the like may refer to a RAN 510 that operates in an NR or 5G system 500, and the term “E-UTRAN” or the like may refer to a RAN 510 that operates in an LTE or 4G system 500. The UEs 501 utilize connections (or channels) 503 and 504, respectively, each of which comprises a physical communications interface or layer (discussed in further detail below).

In this example, the connections 503 and 504 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, a 5G protocol, a NR protocol, and/or any of the other communications protocols discussed herein. In embodiments, the UEs 501 may directly exchange communication data via a ProSe interface 505. The ProSe interface 505 may alternatively be referred to as a SL interface 505 and may comprise one or more logical channels, including but not limited to a PSCCH, a PSSCH, a PSDCH, and a PSBCH.

The UE 501b is shown to be configured to access an AP 506 (also referred to as “WLAN node 506,” “WLAN 506,” “WLAN Termination 506,” “WT 506” or the like) via connection 507. The connection 507 can comprise a local wireless connection, such as a connection consistent with any IEEE 802.11 protocol, wherein the AP 506 would comprise a wireless fidelity (Wi-Fi®) router. In this example, the AP 506 is shown to be connected to the Internet without connecting to the core network of the wireless system (described in further detail below). In various embodiments, the UE 501b, RAN 510, and AP 506 may be configured to utilize LWA operation and/or LWIP operation. The LWA operation may involve the UE 501b in RRC CONNECTED being configured by a RAN node 511a-b to utilize radio resources of LTE and WLAN. LWIP operation may involve the UE 501b using WLAN radio resources (e.g., connection 507) via IPsec protocol tunneling to authenticate and encrypt packets (e.g., IP packets) sent over the connection 507. IPsec tunneling may include encapsulating the entirety of original IP packets and adding a new packet header, thereby protecting the original header of the IP packets.

The RAN 510 can include one or more AN nodes or RAN nodes 511a and 511b (collectively referred to as “RAN nodes 511” or “RAN node 511”) that enable the connections 503 and 504. As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 511 that operates in an NR or 5G system 500 (for example, a gNB), and the term “E-UTRAN node” or the like may refer to a RAN node 511 that operates in an LTE or 4G system 500 (e.g., an eNB). According to various embodiments, the RAN nodes 511 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the RAN nodes 511 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes 511; a MAC/PHY split wherein RRC, PDCP, RLC, and MAC layers are operated by the CRAN/vBBUP and the PHY layer is operated by individual RAN nodes 511; or a “lower PHY” split wherein RRC, PDCP, RLC, MAC layers and upper portions of the PHY layer are operated by the CRAN/vBBUP and lower portions of the PHY layer are operated by individual RAN nodes 511. This virtualized framework allows the freed-up processor cores of the RAN nodes 511 to perform other virtualized applications. In some implementations, an individual RAN node 511 may represent individual gNB-DUs that are connected to a gNB-CU via individual F 1 interfaces (not shown by FIG. 5). In these implementations, the gNB-DUs may include one or more remote radio heads or RFEMs, and the gNB-CU may be operated by a server that is located in the RAN 510 (not shown) or by a server pool in a similar manner as the CRAN/vBBUP. Additionally or alternatively, one or more of the RAN nodes 511 may be next generation eNBs (ng-eNBs), which are RAN nodes that provide E-UTRA user plane and control plane protocol terminations toward the UEs 501, and are connected to a 5GC via an NG interface (discussed infra).

In V2X scenarios one or more of the RAN nodes 511 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs 501 (vUEs 501). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) and/or provide connectivity to one or more cellular networks to provide uplink and downlink communications. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller and/or a backhaul network.

Any of the RAN nodes 511 can terminate the air interface protocol and can be the first point of contact for the UEs 501. In some embodiments, any of the RAN nodes 511 can fulfill various logical functions for the RAN 510 including, but not limited to, radio network controller (RNC) functions such as radio bearer management, uplink and downlink dynamic radio resource management and data packet scheduling, and mobility management.

In embodiments, the UEs 501 can be configured to communicate using OFDM communication signals with each other or with any of the RAN nodes 511 over a multicarrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 511 to the UEs 501, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

According to various embodiments, the UEs 501 and the RAN nodes 511 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band.

To operate in the unlicensed spectrum, the UEs 501 and the RAN nodes 511 may operate using LAA, eLAA, and/or feLAA mechanisms. In these implementations, the UEs 501 and the RAN nodes 511 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UEs 501 RAN nodes 511, etc.) senses a medium (for example, a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA/CA. Here, when a WLAN node (e.g., a mobile station (MS) such as UE 501, AP 506, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 9 microseconds (μs); however, the size of the CWS and a MCOT (for example, a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the bandwidths of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 501 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH carries user data and higher-layer signaling to the UEs 501. The PDCCH carries information about the transport format and resource allocations related to the PDSCH channel, among other things. It may also inform the UEs 501 about the transport format, resource allocation, and HARQ information related to the uplink shared channel. Typically, downlink scheduling (assigning control and shared channel resource blocks to the UE 501b within a cell) may be performed at any of the RAN nodes 511 based on channel quality information fed back from any of the UEs 501. The downlink resource assignment information may be sent on the PDCCH used for (e.g., assigned to) each of the UEs 501.

The PDCCH uses CCEs to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as REGs. Four Quadrature Phase Shift Keying (QPSK) symbols may be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an EPDCCH that uses PDSCH resources for control information transmission. The EPDCCH may be transmitted using one or more ECCEs. Similar to above, each ECCE may correspond to nine sets of four physical resource elements known as an EREGs. An ECCE may have other numbers of EREGs in some situations.

The RAN nodes 511 may be configured to communicate with one another via interface 512. In embodiments where the system 500 is an LTE system (e.g., when CN 520 is an EPC), the interface 512 may be an X2 interface 512. The X2 interface may be defined between two or more RAN nodes 511 (e.g., two or more eNBs and the like) that connect to EPC 520, and/or between two eNBs connecting to EPC 520. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 501 from an SeNB for user data; information of PDCP PDUs that were not delivered to a UE 501; information about a current minimum desired buffer size at the SeNB for transmitting to the UE user data; and the like. The X2-C may provide intra-LTE access mobility functionality, including context transfers from source to target eNBs, user plane transport control, etc.; load management functionality; as well as inter-cell interference coordination functionality.

In embodiments where the system 500 is a 5G or NR system (e.g., when CN 520 is an 5GC), the interface 512 may be an Xn interface 512. The Xn interface is defined between two or more RAN nodes 511 (e.g., two or more gNBs and the like) that connect to 5GC 520, between a RAN node 511 (e.g., a gNB) connecting to 5GC 520 and an eNB, and/or between two eNBs connecting to 5GC 520. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 501 in a connected mode (e.g., CM-CONNECTED) including functionality to manage the UE mobility for connected mode between one or more RAN nodes 511. The mobility support may include context transfer from an old (source) serving RAN node 511 to new (target) serving RAN node 511; and control of user plane tunnels between old (source) serving RAN node 511 to new (target) serving RAN node 511. A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

The RAN 510 is shown to be communicatively coupled to a core network—in this embodiment, core network (CN) 520. The CN 520 may comprise a plurality of network elements 522, which are configured to offer various data and telecommunications services to customers/subscribers (e.g., users of UEs 501) who are connected to the CN 520 via the RAN 510. The components of the CN 520 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 520 may be referred to as a network slice, and a logical instantiation of a portion of the CN 520 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 530 may be an element offering applications that use IP bearer resources with the core network (e.g., UMTS PS domain, LTE PS data services, etc.). The application server 530 can also be configured to support one or more communication services (e.g., VoIP sessions, PTT sessions, group communication sessions, social networking services, etc.) for the UEs 501 via the EPC 520.

In embodiments, the CN 520 may be a 5GC (referred to as “5GC 520” or the like), and the RAN 510 may be connected with the CN 520 via an NG interface 513. In embodiments, the NG interface 513 may be split into two parts, an NG user plane (NG-U) interface 514, which carries traffic data between the RAN nodes 511 and a UPF, and the S1 control plane (NG-C) interface 515, which is a signaling interface between the RAN nodes 511 and AMFs.

In embodiments, the CN 520 may be a 5G CN (referred to as “5GC 520” or the like), while in other embodiments, the CN 520 may be an EPC). Where CN 520 is an EPC (referred to as “EPC 520” or the like), the RAN 510 may be connected with the CN 520 via an S1 interface 513. In embodiments, the S1 interface 513 may be split into two parts, an S1 user plane (S1-U) interface 514, which carries traffic data between the RAN nodes 511 and the S-GW, and the S1-MME interface 515, which is a signaling interface between the RAN nodes 511 and MMES.

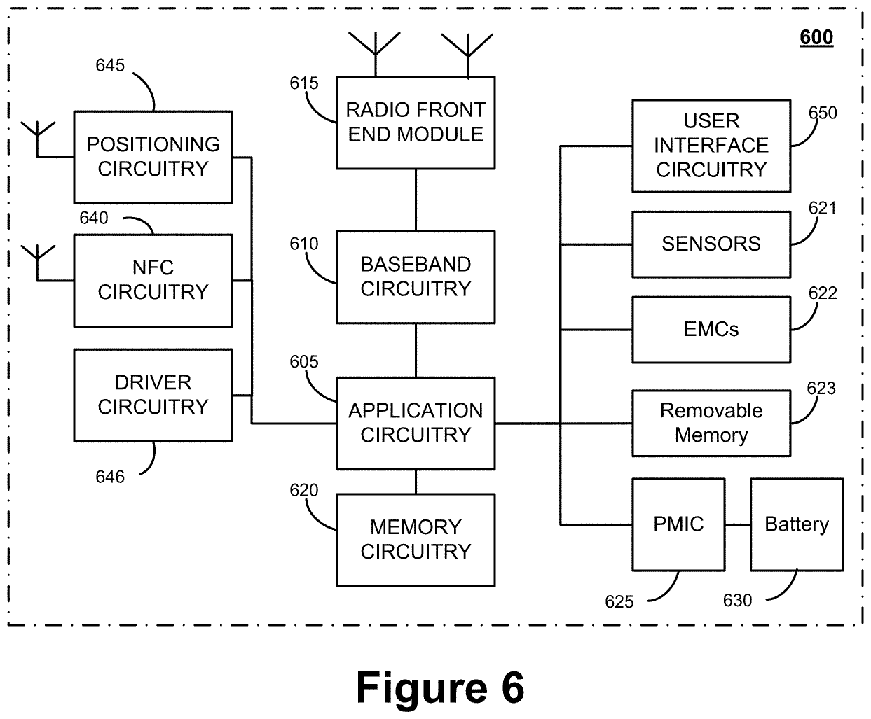

FIG. 6 illustrates an example of a platform 600 (or “device 600”) in accordance with various embodiments. In embodiments, the computer platform 600 may be suitable for use as UEs 501a-b, application servers 530, and/or any other element/device discussed herein. The platform 600 may include any combinations of the components shown in the example. The components of platform 600 may be implemented as integrated circuits (ICs), portions thereof, discrete electronic devices, or other modules, logic, hardware, software, firmware, or a combination thereof adapted in the computer platform 600, or as components otherwise incorporated within a chassis of a larger system. The block diagram of FIG. 6 is intended to show a high level view of components of the computer platform 600. However, some of the components shown may be omitted, additional components may be present, and different arrangement of the components shown may occur in other implementations.

Application circuitry 605 includes circuitry such as, but not limited to one or more processors (or processor cores), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 605 may be coupled with or may include memory/storage elements and may be configured to execute instructions stored in the memory/storage to enable various applications or operating systems to run on the system 600. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 605 may include, for example, one or more processor cores, one or more application processors, one or more GPUs, one or more RISC processors, one or more ARM processors, one or more CISC processors, one or more DSP, one or more FPGAs, one or more PLDs, one or more ASICs, one or more microprocessors or controllers, a multithreaded processor, an ultra-low voltage processor, an embedded processor, some other known processing element, or any suitable combination thereof. In some embodiments, the application circuitry 605 may comprise, or may be, a special-purpose processor/controller to operate according to the various embodiments herein.

As examples, the processor(s) of application circuitry 605 may include an Intel® Architecture Core™ based processor, such as a Quark™, an Atom™, an i3, an i5, an i7, or an MCU-class processor, or another such processor available from Intel® Corporation, Santa Clara, Calif. The processors of the application circuitry 605 may also be one or more of Advanced Micro Devices (AMD) Ryzen® processor(s) or Accelerated Processing Units (APUs); A5-A9 processor(s) from Apple® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 605 may be a part of a system on a chip (SoC) in which the application circuitry 605 and other components are formed into a single integrated circuit, or a single package, such as the Edison™ or Galileo™ SoC boards from Intel® Corporation.

Additionally or alternatively, application circuitry 605 may include circuitry such as, but not limited to, one or more a field-programmable devices (FPDs) such as FPGAs and the like; programmable logic devices (PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry 605 may comprise logic blocks or logic fabric, and other interconnected resources that may be programmed to perform various functions, such as the procedures, methods, functions, etc. of the various embodiments discussed herein. In such embodiments, the circuitry of application circuitry 605 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up tables (LUTs) and the like.

The baseband circuitry 610 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 610 are discussed infra with regard to Figure XT.

The RFEMs 615 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 711 of Figure XT infra), and the RFEM may be connected to multiple antennas. In alternative implementations, both mmWave and sub-mmWave radio functions may be implemented in the same physical RFEM 615, which incorporates both mmWave antennas and sub-mmWave.

The memory circuitry 620 may include any number and type of memory devices used to provide for a given amount of system memory. As examples, the memory circuitry 620 may include one or more of volatile memory including random access memory (RAM), dynamic RAM (DRAM) and/or synchronous dynamic RAM (SDRAM), and nonvolatile memory (NVM) including high-speed electrically erasable memory (commonly referred to as Flash memory), phase change random access memory (PRAM), magnetoresistive random access memory (MRAM), etc. The memory circuitry 620 may be developed in accordance with a Joint Electron Devices Engineering Council (JEDEC) low power double data rate (LPDDR)-based design, such as LPDDR2, LPDDR3, LPDDR4, or the like. Memory circuitry 620 may be implemented as one or more of solder down packaged integrated circuits, single die package (SDP), dual die package (DDP) or quad die package (Q17P), socketed memory modules, dual inline memory modules (DIMMs) including microDIMMs or MiniDIMMs, and/or soldered onto a motherboard via a ball grid array (BGA). In low power implementations, the memory circuitry 620 may be on-die memory or registers associated with the application circuitry 605. To provide for persistent storage of information such as data, applications, operating systems and so forth, memory circuitry 620 may include one or more mass storage devices, which may include, inter alia, a solid state disk drive (SSDD), hard disk drive (HDD), a micro HDD, resistance change memories, phase change memories, holographic memories, or chemical memories, among others. For example, the computer platform 600 may incorporate the three-dimensional (3D) cross-point (XPOINT) memories from Intel® and Micron®.

Removable memory circuitry 623 may include devices, circuitry, enclosures/housings, ports or receptacles, etc. used to couple portable data storage devices with the platform 600. These portable data storage devices may be used for mass storage purposes, and may include, for example, flash memory cards (e.g., Secure Digital (SD) cards, microSD cards, xD picture cards, and the like), and USB flash drives, optical discs, external HDDs, and the like.

The platform 600 may also include interface circuitry (not shown) that is used to connect external devices with the platform 600. The external devices connected to the platform 600 via the interface circuitry include sensor circuitry 621 and electro-mechanical components (EMCs) 622, as well as removable memory devices coupled to removable memory circuitry 623.

The sensor circuitry 621 include devices, modules, or subsystems whose purpose is to detect events or changes in its environment and send the information (sensor data) about the detected events to some other a device, module, subsystem, etc. Examples of such sensors include, inter alia, inertia measurement units (IMUS) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras or lensless apertures); light detection and ranging (LiDAR) sensors; proximity sensors (e.g., infrared radiation detector and the like), depth sensors, ambient light sensors, ultrasonic transceivers; microphones or other like audio capture devices; etc.

EMCs 622 include devices, modules, or subsystems whose purpose is to enable platform 600 to change its state, position, and/or orientation, or move or control a mechanism or (sub)system. Additionally, EMCs 622 may be configured to generate and send messages/signalling to other components of the platform 600 to indicate a current state of the EMCs 622. Examples of the EMCs 622 include one or more power switches, relays including electromechanical relays (EMRs) and/or solid state relays (SSRs), actuators (e.g., valve actuators, etc.), an audible sound generator, a visual warning device, motors (e.g., DC motors, stepper motors, etc.), wheels, thrusters, propellers, claws, clamps, hooks, and/or other like electro-mechanical components. In embodiments, platform 600 is configured to operate one or more EMCs 622 based on one or more captured events and/or instructions or control signals received from a service provider and/or various clients.

In some implementations, the interface circuitry may connect the platform 600 with positioning circuitry 645. The positioning circuitry 645 includes circuitry to receive and decode signals transmitted/broadcasted by a positioning network of a GNSS. Examples of navigation satellite constellations (or GNSS) include United States' GPS, Russia's GLONASS, the European Union's Galileo system, China's BeiDou Navigation Satellite System, a regional navigation system or GNSS augmentation system (e.g., NAVIC), Japan's QZSS, France's DORIS, etc.), or the like. The positioning circuitry 645 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 645 may include a Micro-PNT IC that uses a master timing clock to perform position tracking/estimation without GNSS assistance. The positioning circuitry 645 may also be part of, or interact with, the baseband circuitry 610 and/or RFEMs 615 to communicate with the nodes and components of the positioning network. The positioning circuitry 645 may also provide position data and/or time data to the application circuitry 605, which may use the data to synchronize operations with various infrastructure (e.g., radio base stations), for turn-by-turn navigation applications, or the like

In some implementations, the interface circuitry may connect the platform 600 with Near-Field Communication (NFC) circuitry 640. NFC circuitry 640 is configured to provide contactless, short-range communications based on radio frequency identification (RFID) standards, wherein magnetic field induction is used to enable communication between NFC circuitry 640 and NFC-enabled devices external to the platform 600 (e.g., an “NFC touchpoint”). NFC circuitry 640 comprises an NFC controller coupled with an antenna element and a processor coupled with the NFC controller. The NFC controller may be a chip/IC providing NFC functionalities to the NFC circuitry 640 by executing NFC controller firmware and an NFC stack. The NFC stack may be executed by the processor to control the NFC controller, and the NFC controller firmware may be executed by the NFC controller to control the antenna element to emit short-range RF signals. The RF signals may power a passive NFC tag (e.g., a microchip embedded in a sticker or wristband) to transmit stored data to the NFC circuitry 640, or initiate data transfer between the NFC circuitry 640 and another active NFC device (e.g., a smartphone or an NFC-enabled POS terminal) that is proximate to the platform 600.

The driver circuitry 646 may include software and hardware elements that operate to control particular devices that are embedded in the platform 600, attached to the platform 600, or otherwise communicatively coupled with the platform 600. The driver circuitry 646 may include individual drivers allowing other components of the platform 600 to interact with or control various input/output (I/O) devices that may be present within, or connected to, the platform 600. For example, driver circuitry 646 may include a display driver to control and allow access to a display device, a touchscreen driver to control and allow access to a touchscreen interface of the platform 600, sensor drivers to obtain sensor readings of sensor circuitry 621 and control and allow access to sensor circuitry 621, EMC drivers to obtain actuator positions of the EMCs 622 and/or control and allow access to the EMCs 622, a camera driver to control and allow access to an embedded image capture device, audio drivers to control and allow access to one or more audio devices.

The power management integrated circuitry (PMIC) 625 (also referred to as “power management circuitry 625”) may manage power provided to various components of the platform 600. In particular, with respect to the baseband circuitry 610, the PMIC 625 may control power-source selection, voltage scaling, battery charging, or DC-to-DC conversion. The PMIC 625 may often be included when the platform 600 is capable of being powered by a battery 630, for example, when the device is included in a UE 501a-b.

In some embodiments, the PMIC 625 may control, or otherwise be part of, various power saving mechanisms of the platform 600. For example, if the platform 600 is in an RRC Connected state, where it is still connected to the RAN node as it expects to receive traffic shortly, then it may enter a state known as Discontinuous Reception Mode (DRX) after a period of inactivity. During this state, the platform 600 may power down for brief intervals of time and thus save power. If there is no data traffic activity for an extended period of time, then the platform 600 may transition off to an RRC Idle state, where it disconnects from the network and does not perform operations such as channel quality feedback, handover, etc. The platform 600 goes into a very low power state and it performs paging where again it periodically wakes up to listen to the network and then powers down again. The platform 600 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 630 may power the platform 600, although in some examples the platform 600 may be mounted deployed in a fixed location, and may have a power supply coupled to an electrical grid. The battery 630 may be a lithium ion battery, a metal-air battery, such as a zinc-air battery, an aluminum-air battery, a lithium-air battery, and the like. In some implementations, such as in V2X applications, the battery 630 may be a typical lead-acid automotive battery.

In some implementations, the battery 630 may be a “smart battery,” which includes or is coupled with a Battery Management System (BMS) or battery monitoring integrated circuitry. The BMS may be included in the platform 600 to track the state of charge (SoCh) of the battery 630. The BMS may be used to monitor other parameters of the battery 630 to provide failure predictions, such as the state of health (SoH) and the state of function (SoF) of the battery 630. The BMS may communicate the information of the battery 630 to the application circuitry 605 or other components of the platform 600. The BMS may also include an analog-to-digital (ADC) convertor that allows the application circuitry 605 to directly monitor the voltage of the battery 630 or the current flow from the battery 630. The battery parameters may be used to determine actions that the platform 600 may perform, such as transmission frequency, network operation, sensing frequency, and the like.

A power block, or other power supply coupled to an electrical grid may be coupled with the BMS to charge the battery 630. In some examples, the power block may be replaced with a wireless power receiver to obtain the power wirelessly, for example, through a loop antenna in the computer platform 600. In these examples, a wireless battery charging circuit may be included in the BMS. The specific charging circuits chosen may depend on the size of the battery 630, and thus, the current required. The charging may be performed using the Airfuel standard promulgated by the Airfuel Alliance, the Qi wireless charging standard promulgated by the Wireless Power Consortium, or the Rezence charging standard promulgated by the Alliance for Wireless Power, among others.

User interface circuitry 650 includes various input/output (I/O) devices present within, or connected to, the platform 600, and includes one or more user interfaces designed to enable user interaction with the platform 600 and/or peripheral component interfaces designed to enable peripheral component interaction with the platform 600. The user interface circuitry 650 includes input device circuitry and output device circuitry. Input device circuitry includes any physical or virtual means for accepting an input including, inter alia, one or more physical or virtual buttons (e.g., a reset button), a physical keyboard, keypad, mouse, touchpad, touchscreen, microphones, scanner, headset, and/or the like. The output device circuitry includes any physical or virtual means for showing information or otherwise conveying information, such as sensor readings, actuator position(s), or other like information. Output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 600. The output device circuitry may also include speakers or other audio emitting devices, printer(s), and/or the like. In some embodiments, the sensor circuitry 621 may be used as the input device circuitry (e.g., an image capture device, motion capture device, or the like) and one or more EMCs may be used as the output device circuitry (e.g., an actuator to provide haptic feedback or the like). In another example, NFC circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc.

Although not shown, the components of platform 600 may communicate with one another using a suitable bus or interconnect (IX) technology, which may include any number of technologies, including ISA, EISA, PCI, PCIx, PCIe, a Time-Trigger Protocol (TTP) system, a FlexRay system, or any number of other technologies. The bus/IX may be a proprietary bus/IX, for example, used in a SoC based system. Other bus/IX systems may be included, such as an I2C interface, an SPI interface, point-to-point interfaces, and a power bus, among others.

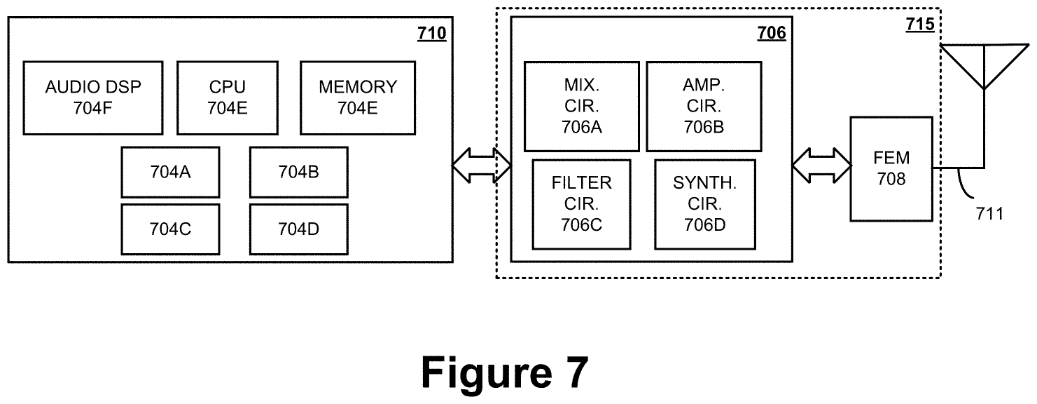

FIG. 7 illustrates example components of baseband circuitry 710 and radio front end modules (RFEM) 715 in accordance with various embodiments. The baseband circuitry 710 corresponds to the baseband circuitry 610 of FIG. 6. The RFEM 715 corresponds to the RFEM 615 of FIG. 6. As shown, the RFEMs 715 may include Radio Frequency (RF) circuitry 706, front-end module (FEM) circuitry 708, antenna array 711 coupled together at least as shown.

The baseband circuitry 710 includes circuitry and/or control logic configured to carry out various radio/network protocol and radio control functions that enable communication with one or more radio networks via the RF circuitry 706. The radio control functions may include, but are not limited to, signal modulation/demodulation, encoding/decoding, radio frequency shifting, etc. In some embodiments, modulation/demodulation circuitry of the baseband circuitry 710 may include Fast-Fourier Transform (FFT), precoding, or constellation mapping/demapping functionality. In some embodiments, encoding/decoding circuitry of the baseband circuitry 710 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments. The baseband circuitry 710 is configured to process baseband signals received from a receive signal path of the RF circuitry 706 and to generate baseband signals for a transmit signal path of the RF circuitry 706. The baseband circuitry 710 is configured to interface with application 605 (see FIG. 6) for generation and processing of the baseband signals and for controlling operations of the RF circuitry 706. The baseband circuitry 710 may handle various radio control functions.

The aforementioned circuitry and/or control logic of the baseband circuitry 710 may include one or more single or multi-core processors. For example, the one or more processors may include a 3G baseband processor 704A, a 4G/LTE baseband processor 704B, a 5G/NR baseband processor 704C, or some other baseband processor(s) 704D for other existing generations, generations in development or to be developed in the future (e.g., sixth generation (6G), etc.). In other embodiments, some or all of the functionality of baseband processors 704A-D may be included in modules stored in the memory 704G and executed via a Central Processing Unit (CPU) 704E. In other embodiments, some or all of the functionality of baseband processors 704A-D may be provided as hardware accelerators (e.g., FPGAs, ASICs, etc.) loaded with the appropriate bit streams or logic blocks stored in respective memory cells. In various embodiments, the memory 704G may store program code of a real-time OS (RTOS), which when executed by the CPU 704E (or other baseband processor), is to cause the CPU 704E (or other baseband processor) to manage resources of the baseband circuitry 710, schedule tasks, etc. Examples of the RTOS may include Operating System Embedded (OSE)™ provided by Enea®, Nucleus RTOS™ provided by Mentor Graphics®, Versatile Real-Time Executive (VRTX) provided by Mentor Graphics®, ThreadX™ provided by Express Logic®, FreeRTOS, REX OS provided by Qualcomm®, OKL4 provided by Open Kernel (OK) Labs®, or any other suitable RTOS, such as those discussed herein. In addition, the baseband circuitry 710 includes one or more audio digital signal processor(s) (DSP) 704F. The audio DSP(s) 704F include elements for compression/decompression and echo cancellation and may include other suitable processing elements in other embodiments.

In some embodiments, each of the processors 704A-704E include respective memory interfaces to send/receive data to/from the memory 704G. The baseband circuitry 710 may further include one or more interfaces to communicatively couple to other circuitries/devices, such as an interface to send/receive data to/from memory external to the baseband circuitry 710; an application circuitry interface to send/receive data to/from the application circuitry 605 of FIG. 6); an RF circuitry interface to send/receive data to/from RF circuitry 706 of Figure XT; a wireless hardware connectivity interface to send/receive data to/from one or more wireless hardware elements (e.g., Near Field Communication (NFC) components, Bluetooth®/Bluetooth® Low Energy components, Wi-Fi® components, and/or the like); and a power management interface to send/receive power or control signals to/from the PMIC 625.

In alternate embodiments (which may be combined with the above described embodiments), baseband circuitry 710 comprises one or more digital baseband systems, which are coupled with one another via an interconnect subsystem and to a CPU subsystem, an audio subsystem, and an interface subsystem. The digital baseband subsystems may also be coupled to a digital baseband interface and a mixed-signal baseband subsystem via another interconnect subsystem. Each of the interconnect subsystems may include a bus system, point-to-point connections, network-on-chip (NOC) structures, and/or some other suitable bus or interconnect technology, such as those discussed herein. The audio subsystem may include DSP circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry 710 may include protocol processing circuitry with one or more instances of control circuitry (not shown) to provide control functions for the digital baseband circuitry and/or radio frequency circuitry (e.g., the radio front end modules 715).

Although not shown by FIG. 7, in some embodiments, the baseband circuitry 710 includes individual processing device(s) to operate one or more wireless communication protocols (e.g., a “multi-protocol baseband processor” or “protocol processing circuitry”) and individual processing device(s) to implement PHY layer functions. In these embodiments, the PHY layer functions include the aforementioned radio control functions. In these embodiments, the protocol processing circuitry operates or implements various protocol layers/entities of one or more wireless communication protocols. In a first example, the protocol processing circuitry may operate LTE protocol entities and/or 5G/NR protocol entities when the baseband circuitry 710 and/or RF circuitry 706 are part of mmWave communication circuitry or some other suitable cellular communication circuitry. In the first example, the protocol processing circuitry would operate MAC, RLC, PDCP, SDAP, RRC, and NAS functions. In a second example, the protocol processing circuitry may operate one or more IEEE-based protocols when the baseband circuitry 710 and/or RF circuitry 706 are part of a Wi-Fi communication system. In the second example, the protocol processing circuitry would operate Wi-Fi MAC and logical link control (LLC) functions. The protocol processing circuitry may include one or more memory structures (e.g., 704G) to store program code and data for operating the protocol functions, as well as one or more processing cores to execute the program code and perform various operations using the data. The baseband circuitry 710 may also support radio communications for more than one wireless protocol.

The various hardware elements of the baseband circuitry 710 discussed herein may be implemented, for example, as a solder-down substrate including one or more integrated circuits (ICs), a single packaged IC soldered to a main circuit board or a multi-chip module containing two or more ICs. In one example, the components of the baseband circuitry 710 may be suitably combined in a single chip or chipset, or disposed on a same circuit board. In another example, some or all of the constituent components of the baseband circuitry 710 and RF circuitry 706 may be implemented together such as, for example, a system on a chip (SoC) or System-in-Package (SiP). In another example, some or all of the constituent components of the baseband circuitry 710 may be implemented as a separate SoC that is communicatively coupled with and RF circuitry 706 (or multiple instances of RF circuitry 706). In yet another example, some or all of the constituent components of the baseband circuitry 710 and the application circuitry 605 may be implemented together as individual SoCs mounted to a same circuit board (e.g., a “multi-chip package”).

In some embodiments, the baseband circuitry 710 may provide for communication compatible with one or more radio technologies. For example, in some embodiments, the baseband circuitry 710 may support communication with an E-UTRAN or other WMAN, a WLAN, a WPAN. Embodiments in which the baseband circuitry 710 is configured to support radio communications of more than one wireless protocol may be referred to as multi-mode baseband circuitry.

RF circuitry 706 may enable communication with wireless networks using modulated electromagnetic radiation through a non-solid medium. In various embodiments, the RF circuitry 706 may include switches, filters, amplifiers, etc. to facilitate the communication with the wireless network. RF circuitry 706 may include a receive signal path, which may include circuitry to down-convert RF signals received from the FEM circuitry 708 and provide baseband signals to the baseband circuitry 710. RF circuitry 706 may also include a transmit signal path, which may include circuitry to up-convert baseband signals provided by the baseband circuitry 710 and provide RF output signals to the FEM circuitry 708 for transmission.

In some embodiments, the receive signal path of the RF circuitry 706 may include mixer circuitry 706a, amplifier circuitry 706b and filter circuitry 706c. In some embodiments, the transmit signal path of the RF circuitry 706 may include filter circuitry 706c and mixer circuitry 706a. RF circuitry 706 may also include synthesizer circuitry 706d for synthesizing a frequency for use by the mixer circuitry 706a of the receive signal path and the transmit signal path. In some embodiments, the mixer circuitry 706a of the receive signal path may be configured to down-convert RF signals received from the FEM circuitry 708 based on the synthesized frequency provided by synthesizer circuitry 706d. The amplifier circuitry 706b may be configured to amplify the down-converted signals and the filter circuitry 706c may be a low-pass filter (LPF) or band-pass filter (BPF) configured to remove unwanted signals from the down-converted signals to generate output baseband signals. Output baseband signals may be provided to the baseband circuitry 710 for further processing. In some embodiments, the output baseband signals may be zero-frequency baseband signals, although this is not a requirement. In some embodiments, mixer circuitry 706a of the receive signal path may comprise passive mixers, although the scope of the embodiments is not limited in this respect.

In some embodiments, the mixer circuitry 706a of the transmit signal path may be configured to up-convert input baseband signals based on the synthesized frequency provided by the synthesizer circuitry 706d to generate RF output signals for the FEM circuitry 708. The baseband signals may be provided by the baseband circuitry 710 and may be filtered by filter circuitry 706c.

In some embodiments, the mixer circuitry 706a of the receive signal path and the mixer circuitry 706a of the transmit signal path may include two or more mixers and may be arranged for quadrature downconversion and upconversion, respectively. In some embodiments, the mixer circuitry 706a of the receive signal path and the mixer circuitry 706a of the transmit signal path may include two or more mixers and may be arranged for image rejection (e.g., Hartley image rejection). In some embodiments, the mixer circuitry 706a of the receive signal path and the mixer circuitry 706a of the transmit signal path may be arranged for direct downconversion and direct upconversion, respectively. In some embodiments, the mixer circuitry 706a of the receive signal path and the mixer circuitry 706a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 706 may include analog-to-digital converter (ADC) and digital-to-analog converter (DAC) circuitry and the baseband circuitry 710 may include a digital baseband interface to communicate with the RF circuitry 706.

In some dual-mode embodiments, a separate radio IC circuitry may be provided for processing signals for each spectrum, although the scope of the embodiments is not limited in this respect.

In some embodiments, the synthesizer circuitry 706d may be a fractional-N synthesizer or a fractional N/N+1 synthesizer, although the scope of the embodiments is not limited in this respect as other types of frequency synthesizers may be suitable. For example, synthesizer circuitry 706d may be a delta-sigma synthesizer, a frequency multiplier, or a synthesizer comprising a phase-locked loop with a frequency divider.

The synthesizer circuitry 706d may be configured to synthesize an output frequency for use by the mixer circuitry 706a of the RF circuitry 706 based on a frequency input and a divider control input. In some embodiments, the synthesizer circuitry 706d may be a fractional N/N+1 synthesizer.

In some embodiments, frequency input may be provided by a voltage controlled oscillator (VCO), although that is not a requirement. Divider control input may be provided by either the baseband circuitry 710 or the application circuitry 605 depending on the desired output frequency. In some embodiments, a divider control input (e.g., N) may be determined from a look-up table based on a channel indicated by the application circuitry 605.

Synthesizer circuitry 706d of the RF circuitry 706 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 706d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 706 may include an IQ/polar converter.

FEM circuitry 708 may include a receive signal path, which may include circuitry configured to operate on RF signals received from antenna array 711, amplify the received signals and provide the amplified versions of the received signals to the RF circuitry 706 for further processing. FEM circuitry 708 may also include a transmit signal path, which may include circuitry configured to amplify signals for transmission provided by the RF circuitry 706 for transmission by one or more of antenna elements of antenna array 711. In various embodiments, the amplification through the transmit or receive signal paths may be done solely in the RF circuitry 706, solely in the FEM circuitry 708, or in both the RF circuitry 706 and the FEM circuitry 708.

In some embodiments, the FEM circuitry 708 may include a TX/RX switch to switch between transmit mode and receive mode operation. The FEM circuitry 708 may include a receive signal path and a transmit signal path. The receive signal path of the FEM circuitry 708 may include an LNA to amplify received RF signals and provide the amplified received RF signals as an output (e.g., to the RF circuitry 706). The transmit signal path of the FEM circuitry 708 may include a power amplifier (PA) to amplify input RF signals (e.g., provided by RF circuitry 706), and one or more filters to generate RF signals for subsequent transmission by one or more antenna elements of the antenna array 711.

The antenna array 711 comprises one or more antenna elements, each of which is configured convert electrical signals into radio waves to travel through the air and to convert received radio waves into electrical signals. For example, digital baseband signals provided by the baseband circuitry 710 is converted into analog RF signals (e.g., modulated waveform) that will be amplified and transmitted via the antenna elements of the antenna array 711 including one or more antenna elements (not shown). The antenna elements may be omnidirectional, direction, or a combination thereof. The antenna elements may be formed in a multitude of arranges as are known and/or discussed herein. The antenna array 711 may comprise microstrip antennas or printed antennas that are fabricated on the surface of one or more printed circuit boards. The antenna array 711 may be formed in as a patch of metal foil (e.g., a patch antenna) in a variety of shapes, and may be coupled with the RF circuitry 706 and/or FEM circuitry 708 using metal transmission lines or the like.

Processors of the application circuitry 605 and processors of the baseband circuitry 710 may be used to execute elements of one or more instances of a protocol stack. For example, processors of the baseband circuitry 710, alone or in combination, may be used execute Layer 3, Layer 2, or Layer 1 functionality, while processors of the application circuitry 605 may utilize data (e.g., packet data) received from these layers and further execute Layer 4 functionality (e.g., TCP and UDP layers). As referred to herein, Layer 3 may comprise a RRC layer, described in further detail below. As referred to herein, Layer 2 may comprise a MAC layer, an RLC layer, and a PDCP layer, described in further detail below. As referred to herein, Layer 1 may comprise a PHY layer of a UE/RAN node, described in further detail below.

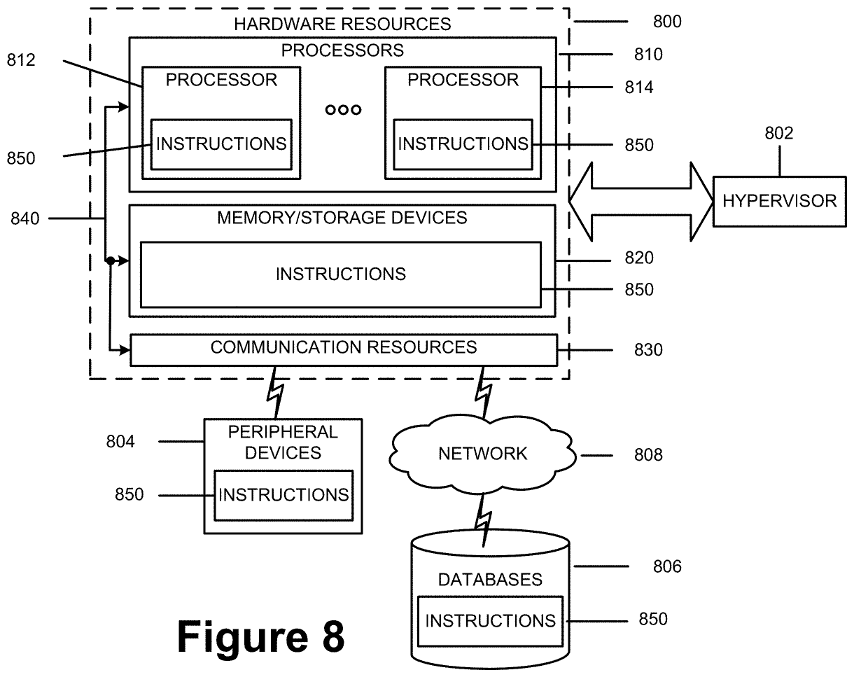

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814. The processor(s) 810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 may include main memory, disk storage, or any suitable combination thereof. The memory/storage devices 820 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 830 may include interconnection or network interface components or other suitable devices to communicate with one or more peripheral devices 804 or one or more databases 806 via a network 808. For example, the communication resources 830 may include wired communication components (e.g., for coupling via USB), cellular communication components, NFC components, Bluetooth® (or Bluetooth® Low Energy) components, Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

### EXAMPLES

Some non-limiting examples of various embodiments are provided below.

Example 1 is one or more computer-readable media (CRM), e.g. transitory or non-transitory CRM, having instructions, stored thereon, that when executed cause a user equipment (UE) to: sense for activity on a sidelink channel within a configurable sensing window duration; select sidelink resources of the sidelink channel to use for a sidelink transmission, the sidelink transmission including an initial transmission and re-transmissions of a sidelink message including one or more transport blocks (TBs); and encode, for transmission on a physical sidelink control channel (PSCCH), a sidelink control information (SCI) that includes resource reservation information to indicate the selected sidelink resources are reserved for subsequent transmissions or re-transmissions of the one or more TBs.

Example 2 is the one or more CRM of Example 1, wherein the SCI further includes an indication of a transport block (TB) redundancy version associated with the sidelink message and a multiple input, multiple output (MIMO) mode for the sidelink message.

Example 3 is the one or more CRM of Example 2, wherein the SCI further includes: a priority indicator to indicate a priority of the sidelink transmission; a source identifier of the sidelink transmission; and a destination identifier of the sidelink transmission.

Example 4 is the one or more CRM of Example 1-3, wherein the instructions, when executed, are further to cause the UE to: determine a sensing window position, and shift the sensing window position in time in respective slots towards pre-selected resources, and process transmissions within the sensing window to refine set of candidate resources at least at a time instance prior to a next pre-selected resource minus a processing delay; determine a number of intended transmissions and amount of resources for transmission of one or more of the TBs; determine a resource selection window to be bounded by a minimum of remaining packet delay budget and a minimum resource selection window duration; and determine the number of resources to be reserved by the SCI transmission.

Example 5 is the one or more CRM of Example 1-4, wherein the UE is a first UE, wherein the sidelink transmission is a first sidelink transmission, wherein the SCI is a first SCI, and wherein, to sense the activity on the sidelink channel within a sliding sensing window, the UE is to: decode a second SCI received from a second UE to extract information related to a second sidelink transmission of the second UE, the extracted information including one or more of: occupied and reserved sidelink transmission resources for the second sidelink transmission; a sidelink communication type of the second sidelink transmission; a communication group affiliation of the second sidelink transmission; a quality of service (QoS) level of the second sidelink transmission; or a set of parameters to reproduce demodulation reference signal (DMRS) for physical sidelink shared channel (PSSCH) demodulation and a PSSCH reference signal received power (RSRP) measurement; wherein the determined sidelink resources are further determined based on the extracted information.

Example 6 is the one or more CRM of Example 1-5, wherein the UE is a first UE, wherein the sidelink transmission is a first sidelink transmission, and wherein the instructions, when executed, are further to cause the UE to: identify, based on the sensed activity, a second sidelink transmission and a third sidelink transmission on the sidelink channel; determine that the second sidelink transmission is part of a first group of one or more transmissions and the third sidelink transmission is part of a second group of one or more transmissions; determine a first priority of the first group and a second priority of the second group; and determine the sidelink resources to use for the first sidelink transmission based on the first and second priorities.

Example 7 is the one or more CRM of Example 6, wherein the UE is to decode the first group of one or more transmissions and is not to decode the second group of one or more transmissions wherein the UE is to determine the first group of one or more transmissions to decode based on one or more of a source ID, a destination ID, and a priority level of the respective one or more transmissions.

Example 8 is the one or more CRM of Example 6, wherein the first and second priorities and associated combinations of source and destination IDs correspond to respective reference signal received power (RSRP) measurements over PSCCH or PSSCH and are compared with corresponding RSRP thresholds to determine whether associated resources of the sidelink channel are occupied or considered as a candidate resources for sidelink transmission.

Example 9 is the one or more CRM of Example 1-8, wherein the UE is to select the sidelink resources on the sidelink channel and indicate the selected and reserved resources over a time window of 32 logical slots based on the sensed activity on the sidelink channel within the configurable sensing window duration.

Example 10 is the one or more CRM of Example 1-9, wherein the instructions, when executed, are further to cause the UE to: determine, after the selection of the sidelink resources for the sidelink transmission, that one or more pre-selected but not reserved sidelink resources are collided or one or more of the pre-selected or reserved sidelink resources are preempted by another sidelink transmission of another UE; and select one or more new sidelink resources for the sidelink transmission based on the collision or preemption.

Example 11 is the one or more CRM of Example 1-10, wherein to sense for activity on the sidelink channel and select the sidelink resources to use for the sidelink transmission, the UE is to: identify candidate resources of the sidelink channel over a sensing window sliding over time; pre-select candidate resources for potential sidelink transmission; monitor the candidate resources for activity at least until a time that is a processing delay prior to an earliest transmission associated with the pre-selected candidate resources for potential sidelink transmission; refine the pre-selected candidate resources based on the monitoring and trigger a change for one or more of the pre-selected candidate resources if there is a collision or pre-emption detected; and re-select the sidelink resources from the refined pre-selected candidate resources.

Example 12 is the one or more CRM of Example 1-11, wherein to sense for activity on the sidelink channel, the UE is to sense for both periodic (semi-persistent) and aperiodic (dynamic) sidelink transmissions.

Example 13 is one or more non-transitory computer-readable media (CRM) having instructions, stored thereon, that when executed cause a first user equipment (UE) to: identify a first sidelink transmission of a second UE on a sidelink channel; identify a second sidelink transmission of a third UE on a sidelink channel; determine that the first sidelink transmission is part of a first group of one or more transmissions and the second sidelink transmission is part of a second group of one or more transmissions; determine a first priority of the first group and a second priority of the second group; and select one or more sidelink resources to use for a third sidelink transmission of the first UE based on the first and second priorities.

Example 14 is the one or more CRM of Example 13, wherein the first group of one or more transmissions correspond to sidelink transmissions that are to be decoded by the UE, wherein the second group of one or more transmissions correspond to sidelink transmissions that the UE is not to decode, wherein the first priority is higher priority than the second priority, and wherein the first and second priorities are determined based on one or more of a source ID, a destination ID, and a priority level of the respective sidelink transmissions.

Example 15 is the one or more CRM of Example 13-14, wherein the first group of one or more transmissions are unicast transmissions and the second group of one or more transmissions are groupcast transmissions or broadcast transmissions.

Example 16 is the one or more CRM of Example 13-15, wherein the instructions, when executed, are further to cause the UE to: determine respective reference signal received power (RSRP) thresholds for the first and second transmissions based on the respective first and second priorities, a respective source ID, and a respective destination ID or their respective combination; determine whether resources of the sidelink channel associated with the first and second transmissions are occupied or considered as candidate resources based on the respective RSRP thresholds; and select the sidelink resources for the third sidelink transmission based on the determination of whether the resources are occupied or considered as candidate resources.

Example 17 is the one or more CRM of Example 13-16, wherein the instructions, when executed, are further to cause the UE to transmit the sidelink transmission using the selected sidelink resources.

Example 18 is an apparatus of a user equipment (UE), the apparatus comprising: a central processing unit (CPU) to generate a sidelink message; and baseband circuitry coupled to the CPU. The baseband circuitry is to: sense for activity on a sidelink channel; select sidelink resources of the sidelink channel to use for a sidelink transmission of the sidelink message; encode, for transmission on a physical sidelink control channel (PSCCH), a sidelink control information (SCI) that includes resource reservation information to indicate the selected sidelink resources for reservation for subsequent transmissions or retransmissions of one or more transport blocks (TBs) of the sidelink message; and encode, for transmission on the selected sidelink resources, the sidelink transmission.

Example 19 is the apparatus of Example 18, wherein the sidelink transmission includes an initial transmission of the one or more TBs.

Example 20 is the apparatus of Example 19, wherein the SCI further includes the following information for the sidelink transmission: a redundancy version; a multiple input, multiple output (MIMO) mode; a priority indicator; a source identifier; and a destination identifier.

Example 21 is the apparatus of Example 18-20, wherein the UE is a first UE, wherein the sidelink transmission is a first sidelink transmission, wherein the SCI is a first SCI, and wherein, to sense the activity on the sidelink channel, the baseband circuitry is to: decode a second SCI received from a second UE to extract information related to a second sidelink transmission of the second UE, the extracted information including one or more of: occupied sidelink transmission resources for the second sidelink transmission; a sidelink communication type of the second sidelink transmission; a communication group affiliation of the second sidelink transmission; a quality of service (QoS) level of the second sidelink transmission; or a set of parameters to reproduce a demodulation reference signal (DMRS) for physical sidelink shared channel (PSSCH) demodulation and a reference signal received power (RSRP) measurement; wherein the determined sidelink resources are further determined based on the extracted information.

Example 22 is the apparatus of Example 18-21, wherein the UE is a first UE, wherein the sidelink transmission is a first sidelink transmission, and wherein the baseband circuitry is further to: identify, based on the sensed activity, a second sidelink transmission and a third sidelink transmission on the sidelink channel; determine that the second sidelink transmission is part of a first group of one or more transmissions that the UE is to decode and the third sidelink transmission is part of a second group of one or more transmissions that the UE is not to decode; determine a first priority of the first group and a second priority of the second group, wherein the first priority is higher priority than the second priority; and determine the sidelink resources to use for the first sidelink transmission based on the first and second priorities.

Example 23 is the apparatus of Example 22, wherein the first and second priorities correspond to respective signal power thresholds to determine whether associated resources of the sidelink channel are occupied or considered as a candidate resource for sidelink transmission.

Example 24 is the apparatus of Example 18-23, wherein the baseband circuitry is further to: determine, after the selection of the sidelink resources for the sidelink transmission, that one or more pre-selected but not reserved sidelink resources are collided or one or more of the pre-selected or reserved sidelink resources are preempted by another sidelink transmission of another UE; and select one or more new sidelink resources for the sidelink transmission based on the collision or preemption.

Example 25 is the apparatus of Example 18-24, wherein to sense for activity on the sidelink channel and select the sidelink resources to use for the sidelink transmission, the baseband circuitry is to: identify candidate resources of the sidelink channel over a sensing window sliding over time: pre-select candidate resources for potential sidelink transmission; monitor the candidate resources for activity at least until a time that is a processing delay prior to an earliest transmission associated with the pre-selected candidate resources for potential sidelink transmission; refine the pre-selected candidate resources based on the monitoring and trigger a change for one or more of the pre-selected candidate resources if there is a collision or pre-emption detected; and re-select the sidelink resources from the refined pre-selected candidate resources.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

1. One or more non-transitory computer-readable media (NTCRM) having instructions, stored thereon, that when executed cause a user equipment (UE) to:
sense for activity on a sidelink channel within a configurable sensing window duration;
select sidelink resources of the sidelink channel to use for a sidelink transmission, the sidelink transmission including an initial transmission and re-transmissions of a sidelink message including one or more transport blocks (TBs); and
encode, for transmission on a physical sidelink control channel (PSCCH), a sidelink control information (SCI) that includes resource reservation information to indicate the selected sidelink resources are reserved for subsequent transmissions or re-transmissions of the one or more TBs.

2. The one or more NTCRM of claim 1, wherein the SCI further includes an indication of a transport block (TB) redundancy version associated with the sidelink message and a multiple input, multiple output (MIMO) mode for the sidelink message.

3. The one or more NTCRM of claim 2, wherein the SCI further includes:
a priority indicator to indicate a priority of the sidelink transmission;
a source identifier of the sidelink transmission; and
a destination identifier of the sidelink transmission.

4. The one or more NTCRM of claim 1, wherein the instructions, when executed, are further to cause the UE to:
determine a sensing window position, and shift the sensing window position in time in respective slots towards pre-selected resources, and process transmissions within the sensing window to refine set of candidate resources at least at a time instance prior to a next pre-selected resource minus a processing delay;
determine a number of intended transmissions and amount of resources for transmission of one or more of the TBs;
determine a resource selection window to be bounded by a minimum of remaining packet delay budget and a minimum resource selection window duration; and
determine the number of resources to be reserved by the SCI transmission.

5. The one or more NTCRM of claim 1, wherein the UE is a first UE, wherein the sidelink transmission is a first sidelink transmission, wherein the SCI is a first SCI, and wherein, to sense the activity on the sidelink channel within a sliding sensing window, the UE is to:
decode a second SCI received from a second UE to extract information related to a second sidelink transmission of the second UE, the extracted information including one or more of:
occupied and reserved sidelink transmission resources for the second sidelink transmission;
a sidelink communication type of the second sidelink transmission;
a communication group affiliation of the second sidelink transmission;
a quality of service (QoS) level of the second sidelink transmission; or
a set of parameters to reproduce demodulation reference signal (DMRS) for physical sidelink shared channel (PSSCH) demodulation and a PSSCH reference signal received power (RSRP) measurement;
wherein the determined sidelink resources are further determined based on the extracted information.

6. The one or more NTCRM of claim 1, wherein the UE is a first UE, wherein the sidelink transmission is a first sidelink transmission, and wherein the instructions, when executed, are further to cause the UE to:
identify, based on the sensed activity, a second sidelink transmission and a third sidelink transmission on the sidelink channel;
determine that the second sidelink transmission is part of a first group of one or more transmissions and the third sidelink transmission is part of a second group of one or more transmissions;
determine a first priority of the first group and a second priority of the second group; and
determine the sidelink resources to use for the first sidelink transmission based on the first and second priorities.

7. The one or more NTCRM of claim 6, wherein the UE is to decode the first group of one or more transmissions and is not to decode the second group of one or more transmissions wherein the UE is to determine the first group of one or more transmissions to decode based on one or more of a source ID, a destination ID, and a priority level of the respective one or more transmissions.

8. The one or more NTCRM of claim 6, wherein the first and second priorities and associated combinations of source and destination IDs correspond to respective reference signal received power (RSRP) measurements over PSCCH or PSSCH and are compared with corresponding RSRP thresholds to determine whether associated resources of the sidelink channel are occupied or considered as a candidate resources for sidelink transmission.

9. The one or more NTCRM of claim 1, wherein the UE is to select the sidelink resources on the sidelink channel and indicate the selected and reserved resources over a time window of 32 logical slots based on the sensed activity on the sidelink channel within the configurable sensing window duration.

10. The one or more NTCRM of claim 1, wherein the instructions, when executed, are further to cause the UE to:
determine, after the selection of the sidelink resources for the sidelink transmission, that one or more pre-selected but not reserved sidelink resources are collided or one or more of the pre-selected or reserved sidelink resources are preempted by another sidelink transmission of another UE; and
select one or more new sidelink resources for the sidelink transmission based on the collision or preemption.

11. The one or more NTCRM of claim 1, wherein to sense for activity on the sidelink channel and select the sidelink resources to use for the sidelink transmission, the UE is to:
identify candidate resources of the sidelink channel over a sensing window sliding over time;
pre-select candidate resources for potential sidelink transmission;
monitor the candidate resources for activity at least until a time that is a processing delay prior to an earliest transmission associated with the pre-selected candidate resources for potential sidelink transmission;
refine the pre-selected candidate resources based on the monitoring and trigger a change for one or more of the pre-selected candidate resources if there is a collision or pre-emption detected; and
re-select the sidelink resources from the refined pre-selected candidate resources.

12. The one or more NTCRM of claim 1, wherein to sense for activity on the sidelink channel, the UE is to sense for both periodic (semi-persistent) and aperiodic (dynamic) sidelink transmissions.

13. One or more non-transitory computer-readable media (NTCRM) having instructions, stored thereon, that when executed cause a first user equipment (UE) to:
identify a first sidelink transmission of a second UE on a sidelink channel;
identify a second sidelink transmission of a third UE on a sidelink channel;
determine that the first sidelink transmission is part of a first group of one or more transmissions and the second sidelink transmission is part of a second group of one or more transmissions;
determine a first priority of the first group and a second priority of the second group; and
select one or more sidelink resources to use for a third sidelink transmission of the first UE based on the first and second priorities.

14. The one or more NTCRM of claim 13, wherein the first group of one or more transmissions correspond to sidelink transmissions that are to be decoded by the UE, wherein the second group of one or more transmissions correspond to sidelink transmissions that the UE is not to decode, wherein the first priority is higher priority than the second priority, and wherein the first and second priorities are determined based on one or more of a source ID, a destination ID, and a priority level of the respective sidelink transmissions.

15. The one or more NTCRM of claim 13, wherein the first group of one or more transmissions are unicast transmissions and the second group of one or more transmissions are groupcast transmissions or broadcast transmissions.

16. The one or more NTCRM of claim 13, wherein the instructions, when executed, are further to cause the UE to:
determine respective reference signal received power (RSRP) thresholds for the first and second transmissions based on the respective first and second priorities, a respective source ID, and a respective destination ID or their respective combination;
determine whether resources of the sidelink channel associated with the first and second transmissions are occupied or considered as candidate resources based on the respective RSRP thresholds; and
select the sidelink resources for the third sidelink transmission based on the determination of whether the resources are occupied or considered as candidate resources.

17. The one or more NTCRM of claim 13, wherein the instructions, when executed, are further to cause the UE to transmit the sidelink transmission using the selected sidelink resources.

18. An apparatus of a user equipment (UE), the apparatus comprising:
a central processing unit (CPU) to generate a sidelink message;
baseband circuitry coupled to the CPU, the baseband circuitry to:
sense for activity on a sidelink channel;
select sidelink resources of the sidelink channel to use for a sidelink transmission of the sidelink message;
encode, for transmission on a physical sidelink control channel (PSCCH), a sidelink control information (SCI) that includes resource reservation information to indicate the selected sidelink resources for reservation for subsequent transmissions or retransmissions of one or more transport blocks (TBs) of the sidelink message; and
encode, for transmission on the selected sidelink resources, the sidelink transmission.

19. The apparatus of claim 18, wherein the sidelink transmission includes an initial transmission of the one or more TBs.

20. The apparatus of claim 19, wherein the SCI further includes the following information for the sidelink transmission:
a redundancy version;
a multiple input, multiple output (MIMO) mode;
a priority indicator;
a source identifier; and
a destination identifier.

21. The apparatus of claim 18, wherein the UE is a first UE, wherein the sidelink transmission is a first sidelink transmission, wherein the SCI is a first SCI, and wherein, to sense the activity on the sidelink channel, the baseband circuitry is to:
decode a second SCI received from a second UE to extract information related to a second sidelink transmission of the second UE, the extracted information including one or more of:
occupied sidelink transmission resources for the second sidelink transmission;
a sidelink communication type of the second sidelink transmission;
a communication group affiliation of the second sidelink transmission;
a quality of service (QoS) level of the second sidelink transmission; or
a set of parameters to reproduce a demodulation reference signal (DMRS) for physical sidelink shared channel (PSSCH) demodulation and a reference signal received power (RSRP) measurement
wherein the determined sidelink resources are further determined based on the extracted information.

22. The apparatus of claim 18, wherein the UE is a first UE, wherein the sidelink transmission is a first sidelink transmission, and wherein the baseband circuitry is further to:
identify, based on the sensed activity, a second sidelink transmission and a third sidelink transmission on the sidelink channel;
determine that the second sidelink transmission is part of a first group of one or more transmissions that the UE is to decode and the third sidelink transmission is part of a second group of one or more transmissions that the UE is not to decode;
determine a first priority of the first group and a second priority of the second group, wherein the first priority is higher priority than the second priority; and
determine the sidelink resources to use for the first sidelink transmission based on the first and second priorities.

23. The apparatus of claim 22, wherein the first and second priorities correspond to respective signal power thresholds to determine whether associated resources of the sidelink channel are occupied or considered as a candidate resource for sidelink transmission.

24. The apparatus of claim 18, wherein the baseband circuitry is further to:
determine, after the selection of the sidelink resources for the sidelink transmission, that one or more pre-selected but not reserved sidelink resources are collided or one or more of the pre-selected or reserved sidelink resources are preempted by another sidelink transmission of another UE; and
select one or more new sidelink resources for the sidelink transmission based on the collision or preemption.

25. The apparatus of claim 18, wherein to sense for activity on the sidelink channel and select the sidelink resources to use for the sidelink transmission, the baseband circuitry is to:
identify candidate resources of the sidelink channel over a sensing window sliding over time:
pre-select candidate resources for potential sidelink transmission;
monitor the candidate resources for activity at least until a time that is a processing delay prior to an earliest transmission associated with the pre-selected candidate resources for potential sidelink transmission;
refine the pre-selected candidate resources based on the monitoring and trigger a change for one or more of the pre-selected candidate resources if there is a collision or pre-emption detected; and
re-select the sidelink resources from the refined pre-selected candidate resources.
